(19) United States
(12) Patent Application Publication
(10) Pub. No.: US 2026/0264526 A1
(43) Pub. Date: Sep. 10, 2026

(54) ONBOARD CHARGING SYSTEM USING SPLIT-PHASE MOTOR

(71) Applicants: ELEAPPOWER LTD., North York (CA); THE GOVERNING COUNCIL OF THE UNIVERSITY OF TORONTO, Toronto (CA)

(72) Inventors: Caniggia CASTRO DINIZ VIANA, Toronto (CA); Mehanathan PATHMANATHAN, Toronto (CA); Lokugonaduwage Sachindra Chatumal PERERA, Toronto (CA); Theodore SOONG, Toronto (CA); Peter Waldemar LEHN, Toronto (CA)

(21) Appl. No.: 19/165,496

(22) PCT Filed: Mar. 14, 2023
(86) PCT No.: PCT/CA2023/050332

§ 371 Date: Sep. 15, 2025

(51) Int. Cl. B60L 3/00; H02M 1/14

(52) U.S. Cl. CPC B60L 3/0069; H02M 1/14

(57) ABSTRACT

An integrated charging topology is introduced for drivetrain solutions operating split-phase machines with variations are proposed both for single phase and multi phase variants. An active power decoupling variant is introduced using a single-input space vector decomposition and the usage of a power ripple phasor. This variant approach enables closed-loop control of the harmonic output power ripple (e.g., second harmonic), compensating for unmeasured effects, such as the interfacing inductance periodic energy storage, and allowing for a near-total reduction in the experimental setting. In operation, the control approach can include controlling the average power transfer between the grid and the battery and/or attenuating a second harmonic power ripple.

### FIELD

Embodiments of the present disclosure relate to the field of electronics charging, and more specifically, embodiments relate to devices, systems, control processes, control instruction sets, and methods for electronics charging using split-phase motor connections.

### INTRODUCTION

Electric vehicle (EV) charging constitutes a significant challenge for power processing research. On the one hand, consumers want high rated power, which decreases charging time and eases range anxiety. On the other hand, this objective often leads to more expensive and bulky chargers.

This is especially challenging for onboard chargers, because the onboard chargers significantly impact the above as they need to be carried by the vehicle as the vehicle is moving in operation (e.g., as opposed to fixed infrastructure). Accordingly, improved onboard charging is desirable as it aids in the adoption of green/clean technology, such as electric vehicles. Further, improved approaches may lead to improved efficiency and thus a reduction in overall climate impact and footprint for vehicles, in addition to increased technical performance (e.g., range, charge time).

There can be differences in available charging infrastructure, and these differences can change the viability of different approaches. For example, in certain households and charging stations, there may be multi-phase outlets available, while in others, there may only be single-phase outlets available. Chargers may be provided with differing power and operating characteristics (e.g., voltage, current, presence of harmonics), and it is important to note that there can be safety features that can inadvertently cause issues relating to nuisance tripping. The viability of different approaches can include the ability to adapt to the differences in charging infrastructure, such as the ability to utilize legacy chargers to different types of energy storage devices, etc.

Vehicles, especially passenger vehicles, have a high interest in fast charging.

### SUMMARY

An integrated charging topology is introduced for drivetrain solutions operating split-phase machines. In particular, the approaches described herein are adapted to enable fast charging without requiring the complexity of an onboard charger, instead using control approaches to achieve improved charging characteristics and enabling fast charging. Variations are proposed both for DC, single phase and multi phase variants. In a further variation, there are control approaches that intelligently utilize a combination of at least two, or even three, of DC, single phase, and multi phase variants, switching between different available approaches depending on charge state (e.g., bootstrapped charging, which can be useful for safely charging depleted energy storage devices).

The topology leverages a machine, such as, but not limited to, an open winding machine, using a point (e.g., the middle point, although other points may be used) in the winding of two or more phases as connection points to the grid. The topology can be implemented on physical drivetrain architectures that can include energy storage devices, such as batteries (single or plural), and a variant explained further is the dual inverter drivetrain (which could have two separate energy storage devices, such as two batteries). There can be separate variations for single or dual energy storage devices (e.g., single battery or dual battery).

The drivetrain in this context can operate with an open winding split-phase machine which could be either an induction or synchronous machine. Open winding provides two connection points for inverters, and a connection point in between that is used for connection to the grid. The system can be adapted such that it adds no hardware components to the drivetrain and achieves single-phase charging with active phase decoupling (APD) via an innovative proposed control strategy, which is enabled by introducing the power phasor approach as described in various embodiments herein. The system can be operated in different variations, with one de link, or two dc links, leveraging a dual inverter topology. For example, with respect to a 6-phase open-winding system, the approach adds no components to achieve 3-phase charging, and the approach modifies the windings to have a mid-phase connection. Accordingly, the approach is able to obtain the technical benefit of charging without incurring the cost of additional components. Similarly, single-phase charging can also be achieved without adding any components. However, for the embodiment with active power decoupling strategy (APD) functionality in combination with (e.g., on top of) single-phase charging, the approach does require adding a capacitor and a method of disconnection thereof.

In some embodiments, an auxiliary capacitor (or an auxiliary inductor, depending on the amount of energy to be stored in the inductor/capacitor, and the selection can be based on the cost (expense, weight) for energy storage) is leveraged to implement an APD strategy that eliminates the double-line frequency ripple current into the batteries. A separate switch, from the inverter can be used to connect the auxiliary capacitor/inductor.

APD is described herein but is an optional feature of some embodiments. For an auxiliary inductor, a similar approach as described herein can be contemplated. A power transfer controller regulates active and reactive power from the grid. An active power decoupling controller is introduced using a single-input space vector decomposition and the usage of a power ripple phasor. This approach enables closed-loop control of the harmonic output power ripple (e.g., second harmonic), compensating for unmeasured effects, such as the interfacing inductance periodic energy storage, and allowing for a near-total reduction in the experimental setting. The auxiliary capacitor/inductor is not required in respect of DC embodiments because there is no second harmonic in respect of DC. In view of practical considerations, capacitors may be favoured relative to inductors for reasons of cost, weight, and/or volume.

In operation, the control approach can include controlling the average power transfer between the grid and the battery and/or attenuating a second harmonic power ripple. Average power transfer between the grid and battery may follow a reference, and a power control architecture is configured for, for example, by controlling the oscillator, determining (e.g., computing) phasors (e.g., grid current and voltages). A feedback controller circuit is used for control by minimizing a tracking error, and an input signal can thus be controlled for provisioning by a signal generator, such as a pulse width modulation (PWM) modulator. APD can be achieved, reducing or eliminating a target harmonic ripple. Experimental validation was conducted to validate steady state operation of the system and to investigate transient performance during load changes.

The approach can be practically implemented in a number of different variations. For example, the approach can be implemented using machine instructions stored in a non-transitory machine readable medium (e.g., an article of manufacture) for provisioning to a control circuit that controls activation and/or timing thereof of one or more switch operations (e.g., modulation firmware). The machine instructions modulate the operations of the circuit, and in the context of this application, modulation refers to approaches that allow the system to take an input of a voltage that it is desired to have a system to output, and controls the system to output that voltage by an appropriate choice of parameters, such as, but not limited to a number of times to turn on/off switches that are in that system.

This can include the control of operational aspects such as duty cycles, etc., deciding switch states at different instances in time, representing a combination of which switches are on and which are off.

In an example, a feedback-based circuit can be provided that operates as a controller circuit for coupling to switches of components of a drivetrain. This can be used in a retrofit situation where an existing vehicle drivetrain or vehicle is coupled to the controller circuit to improve various onboard charger characteristics. In another variation, an improved drivetrain is proposed that includes control circuitry or is adapted for coupling with the control circuitry. In another variation, an improved vehicle is proposed that includes the proposed improved drivetrain.

From a practical perspective, the approaches described herein can be directly implemented to modify the traction inverter to add capabilities described herein in various embodiments, and may avoid the requirement for a separate on-board charger. This is beneficial because the on-board charger typically has a significant weight and cost of requiring a transformer and other components.

However, in an alternate scenario, it is possible to avoid modifying the traction inverter, for example, where a manufacturer does not commit to modifying the traction inverter, and an additional circuit can be provided to support the embodiments herein, however, some additional components will need to be added (e.g., inductors, etc.), but this approach is still beneficial as the transformer of the on-board charger can be avoided.

The approach provides an electrical device capable of charging and driving the energy storage means (e.g., energy storage device such as a battery or a capacitor) of an electric vehicle and the motor of an electric vehicle. In a non-limiting example, the system is adapted wherein the electrical device is comprised of a plurality of switches, each one connecting a terminal of the energy storage means to a terminal of the alternating-current motor, wherein a control system is used to control each switch to either connect the energy storage means to the motor stator terminals or not wherein the alternating-current motor stator has at least six terminals connected to the switches, wherein the alternating-current motor stator has at least three terminals not directly connected to switches in the electrical device, termed split-phase nodes, wherein the one or more phases of the alternating motor are split into at least two subwindings, with two subwindings connected to each other at terminals that are not directly connected to switches, wherein, during charging operation, at least two of the split-phase nodes are connected to an electricity network with which electrical energy is exchanged, and wherein the energy storage means is not galvanically isolated from the electricity network during charging operation.

The control system can have the effect of reducing the common-mode current flowing to the electricity network sufficiently to prevent ground fault protection tripping, otherwise referred to as nuisance tripping.

The control system can also have the effect of reducing or eliminating torque production by controlling the state of the switches connected to the terminals of the windings whose split-phase nodes are connected to the electricity network. Switches being controlled can include electrical switches/semiconductor devices (e.g. IGBTs, MOSFETs). This approach, for example, can be implemented through the use of controlling different sub-architectures of the system, to establish specific electrical operational characteristics and modes.

The control system can also have the effect of applying zero zero-sequence voltage to the motor stators. The control system, in some embodiments, controls the operation of the system to track the operation against reference frames, and in some embodiments, there are a specific set of switching states based on various charging voltage space vectors. In operation, the system can be constrained to operate only within or utilize for a significant amount of time specific switching states to cancel out the zero sequence voltage. For example, there can be 64 available states of operation, and the approach can include constraining operation to 20 available states of the available states. The specific state sequence and state time (e.g., dwell time) can be controlled.

The energy storage means can be comprised of more than one energy storage source, wherein each one of the many energy storage sources are not electrically connected to each other other than through the switches and/or the alternating-current motor stator windings.

As described in some embodiments, during charging operation (e.g., single-phase charging operation), the control system reduces the second-harmonic-power-ripple flowing into and out of the energy storage means and/or each energy storage sources.

An additional approach is described in some embodiments for modal control to effectively “bootstrap” operation to charge discharged energy storage devices (e.g., batteries) using a combination of single phase and multi-phase approaches, by operating different connections and disconnecting switches. In this embodiment, the semiconductor devices in the inverter can be different than the disconnecting switches used to connect to the AC network.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a prior art circuit diagram showing an example implementation of an on-board charger.

FIG. 2 is a prior art circuit diagram showing an example integrated charger with PFC functionality.

FIG. 3 is a prior art circuit diagram showing a three-phase integrated onboard charger using nine phase machine.

FIG. 4 is a circuit diagram showing an integrated three-phase charger leveraging split-phase open winding motor architecture and six-leg inverter drivetrain.

FIG. 5 is a circuit diagram showing an integrated three-phase charger leveraging split-phase open winding motor architecture and six-leg inverter drivetrain.

FIG. 6 is a circuit diagram showing a proposed circuit topology, according to some embodiments.

FIG. 7 is a set of waveform diagrams and vector diagrams provided to show a graphical interpretation of power phasors, according to some embodiments.

FIG. 8 is a circuit diagram showing a simplified representation of the active power decoupling control loop, according to some embodiments.

FIG. 9 is a circuit diagram showing a proposed control architecture, defining the desired voltages vₐ, v_{b}, and v_{c}, to be applied by a suitable modulator, according to some embodiments.

FIG. 10 is a set of simulation waveforms during single-phase charging operation with active power decoupling controller disabled, according to some embodiments.

FIG. 11 is a set of graph trace diagrams showing instantaneous grid power, auxiliary capacitor power, and total output power (sum of top and bottom batteries) during single-phase operation with active power decoupling controller disabled, according to some embodiments.

FIG. 12 is a set of graph trace diagrams showing simulation waveforms during single-phase charging operation with active power decoupling controller enabled, according to some embodiments.

FIG. 13 is a set of graph trace diagrams showing instantaneous grid power, auxiliary capacitor power, and total output power (sum of top and bottom batteries) during single-phase operation with active power decoupling controller enabled, according to some embodiments.

FIG. 14 is a set of graph trace diagrams showing a simulation of transient turn on of APD controller, according to some embodiments.

FIG. 15 is a set of graph trace diagrams showing a simulation of transient turn on of APD controller, according to some embodiments.

FIG. 16 is a depiction of an experimental setup, according to some embodiments.

FIG. 17 is a set of graph trace diagrams showing experimentally measured waveforms during single phase charging operation with active power decoupling controller disabled, according to some embodiments.

FIG. 18 is a set of graph trace diagrams showing experimentally measured waveforms during single phase charging operation with active power decoupling controller enabled, illustrative of simulation results, according to some embodiments.

FIG. 19 is a set of graph trace diagrams showing experimentally measured harmonic content of current into the top battery during single-phase charging operation with active power decoupling controller disabled compared with analogous measurement made during operation with active power decoupling controller enabled, illustrative of simulation results, according to some embodiments.

FIG. 20 is a set of graph trace diagrams showing experimentally measured waveforms during single phase charging operation with active power decoupling controller disabled, according to some embodiments.

FIG. 21 is a set of graph trace diagrams showing experimentally measured waveforms during single-phase charging operation with active power decoupling controller enabled, according to some embodiments.

FIG. 22 shows a schematic representation and a proposed dual inverter architecture for a proposed drivetrain with a dual inverter controlling a split-phase, open winding machine, according to some embodiments.

FIG. 23 shows a circuit representation of a three-phase charging configuration of the system, according to some embodiments.

FIG. 24 shows a set of circuit model diagrams showing decoupled representation of the 4 subsystems resulting from the proposed topology during charging operation. Lₛ represents the machine's per-phase leakage inductance and L represents the positive sequence inductance. \vec{U}_{bemf} is the back electromotive force produced by the machine. Cy is the y-capacitance coupling each battery to the vehicle's chassis, according to some embodiments.

FIG. 25 is a set of circuit model diagrams showing a set of decoupled representations of the 4 subsystems resulting from the proposed topology during driving operation, according to some embodiments.

FIG. 26 is a circuit diagram showing an example control architecture that can be used during charging operation of the proposed integrated drivetrain charger, according to some embodiments.

FIG. 27 are vector diagrams showing available voltage space-vector with zero CM voltage, according to some embodiments. Zero vectors are not labeled. FIG. 27(a) shows the available charging voltage space-vector, \vec{V}_{ch}, and FIG. 27(b) shows the available driving voltage space vector, \vec{V}_{dr}.

FIG. 28 is a set of graph trace diagrams showing grid phase quantities under transient step in charging current reference, according to some embodiments. FIG. 28(a) shows grid current and FIG. 28(b) shows grid voltage.

FIG. 29 is a graph diagram showing direct-axis representation of the grid current and its reference value from simulation, according to some embodiments.

FIG. 30 shows a common mode voltage space-vector generated by the dual inverter during charging operation, according to some embodiments.

FIG. 31 is a set of graph trace diagrams showing voltage space-vectors decomposed, averaged over a switching cycle, according to some embodiments. The top graph (a) shows the charging voltage space-vector in SRF. The bottom graph (b) shows the driving voltage space-vector in SRF.

FIG. 32 is a set of illustrative diagrams showing a setup used for experimental verification, according to some embodiments.

FIG. 33 is a set of graph trace diagrams showing experimental results during G2V operation using a conventional PWM.

FIG. 34 is a set of graph trace diagrams showing experimental results during G2V operation using the proposed modulation, according to some embodiments.

FIG. 35 is a set of graph trace diagrams showing experimental results during V2G operation, according to some embodiments.

FIG. 36 is a set of graph trace diagrams showing experimentally measured CM leakage current reduction by the proposed modulation technique, according to some embodiments.

FIG. 37 is a set of graph trace diagrams showing experimental results of CC-CV charging operation with battery emulation power supply EA-PSB, showing data exported by the battery emulator power supply software, according to some embodiments.

FIG. 38 is an example operational mode diagram for a bootstrapping variation, according to some embodiments.

FIG. 39 is an example block diagram showing example components of the system, according to some embodiments.

FIG. 40 is an example vehicle with an improved drivetrain, according to some embodiments.

### DETAILED DESCRIPTION

As described in various embodiments herein, an approach for single-phase and/or multi phase integrated charging topology is introduced. The approach is adapted for drivetrain solutions operating split-phase machines (e.g., three phase or multi-phase), and this can include both single phase and multi phase variations, as introduced in further sections below.

The split-phase connection point topology is proposed as an improved circuit topology and design. In particular, proposed topologies are introduced that utilize rotating power dynamic (e.g., time-varying) phasor control to improve various aspects of onboard charging.

The topology can be implemented on physical drivetrain architectures that can include energy storage devices, such as batteries (single or plural), and a variant explained further is the dual inverter drivetrain (which could have two separate energy storage devices, such as two batteries). Different physical drivetrain architectures have different benefits and drawbacks, and a number of variations will be considered herein. In some embodiments, an auxiliary capacitor is included, and the auxiliary capacitor is adapted for power decoupling.

An oscillator can be provided that is used for determining (e.g., computing, analyzing, detecting) a time-varying phasor from a sinusoidal signal. The oscillator can be used to analyze components of the grid input (e.g., grid current). An active power decoupling (APD) strategy is proposed whereby the choice of an appropriate electrical component and corresponding vector for the capacitor voltage is made, based at least upon a reduction or an elimination of a harmonic power ripple delivered to the energy storage devices (e.g., the second harmonic delivered to the battery/batteries).

From a validation perspective, experimental results may be reasonably interpolated/extrapolated to cover the different proposed variations. Control architectures for controlling electronic component operation can include controller topologies that can be coupled to switching components (e.g., controllable switches) of the drivetrain architectures.

The vehicles can be operated in different states, such as a driving state, a stopping state, a charging state, or a vehicle-to-grid charging state (V2G). During these vehicle operational states, the vehicle itself may have various onboard electronic components, such as onboard chargers. Onboard electronic components contribute to increased weight and volume, and thus, when optimizing for efficiency or range, it is important to keep these to a minimum. During a charging state, the vehicle may be obtaining a charge from a power source, such as an AC source, or a DC source. In the V2G state, the vehicle may be supplying power to the grid (e.g., useful for grid redundancy). The power source may also have certain non-idealities in the power being provided.

In operation, the control approach can include controlling the average power transfer between the grid and the battery and/or attenuating a second harmonic power ripple. Average power transfer between the grid and battery may follow a reference, and a power control architecture is configured for, for example, by controlling the oscillator, determining (e.g., computing) phasors (e.g., grid current and voltages).

A feedback controller circuit is used for control by minimizing a tracking error, and an input signal can thus be controlled for provisioning by a signal generator, such as a pulse width modulation (PWM) modulator. APD can be achieved, reducing or eliminating a target harmonic ripple. Experimental validation was conducted to validate steady state operation of the system and to investigate transient performance during load changes.

The control methodologies can be practically implemented using feedback control systems, such as in a physical controller circuit, a drivetrain (e.g., powertrain) of a vehicle having the physical controller circuit or adapted for phasor control through switch control (e.g., switch modulation), or a vehicle with an improved drivetrain. Drivetrain control software program products (e.g., affixed as machine interpretable instructions in articles of manufacture stored on non-transitory computer readable media) are contemplated, along with special purpose machinery such as controllers operating the machine interpretable instructions adapted to transform the controllers into special purpose machines for drivetrain control.

The topology leverages an open winding machine, using a point (e.g., the middle point, although other points may be used) in the winding of two or more phases as connection points to the grid.

A coil is comprised of multiple turns of conductive wire around a magnetic material with an appropriate insulation around the conductive material. When a coil is used to conduct the stator current of one phase of a three-phase machine, this coil may be called a phase winding of the machine's stator, or simply a phase of the machine's stator. Any coil has at least two points of connection to electric circuitry outside the coil, the beginning and the end of the coil.

Typically, a coil is formed by a conductor surrounded by an insulated material that guides the passage of current. Connection points in a coil are points at which the insulation is not present, such that one can connect the coil to external electric circuitry. In this case, by connection, it means allowance of passage of current to the external electrical circuitry or vice versa. The coil may be manufactured as one object, or may be comprised of two or more independent coils that may be wound around the same magnetic core.

A coil, or phase of a machine stator can have an additional connection point between the beginning and the end points of the coil. There is a potential drawback of the additional connection point in view of cost and a removal of insulation, therefore it would typically not be contemplated, as it could increase cost.

When the additional connection point is added, the coil is said to be a split-phase. An approach to create a split phase, for example, can be to strip the insulation and add connection point/or manufactured two windings of the coil to be put around the magnetic core, and one would connect them together to make a connection point—while there would be incurred winding and insulation cost of the total, and the connection point cost could be incurred at least once more. The connection point between the beginning and the end of a coil is called the split-phase connection point.

When the split-phase divides the coil into two segments with the same number of turns (e.g., split-phase to beginning and split-phase to the end) the split-phase is called mid-point of a coil. Two coils surrounding the same magnetic core structure (in a way that the flux linkage path for both coils face the same magnetic reluctance), having the extremity of each coil connected to one another may, in some cases, be defined as a split-phase coil, with the connection between both coils being the split-phase connection point.

An auxiliary capacitor is leveraged to implement an active power decoupling strategy that eliminates the double-line frequency ripple current into the batteries. A power transfer controller regulates active and reactive power from the grid. An active power decoupling controller is introduced using a single-input space vector decomposition and the new concept of power ripple phasor. This approach enables closed-loop control of the second harmonic output power ripple, compensating for unmeasured effects, such as the interfacing inductance periodic energy storage, and allowing for a near-total reduction in the experimental setting.

Whenever any system tries to extract average power (thus extracting energy) from a single-phase energy source, it also extracts second harmonic power ripple (in addition to average power), which does not transmit significant average energy to the load. When both the current extracted from a voltage source and the voltage thereof are sinusoidal, this is necessarily the case. This does not occur with other harmonics. Thus, the approach of some embodiments are adapted to focus on solving the problem for second harmonic. The APD approach is optional and can be combined with the split-phase approach described herein.

These aspects are described in further detail below.

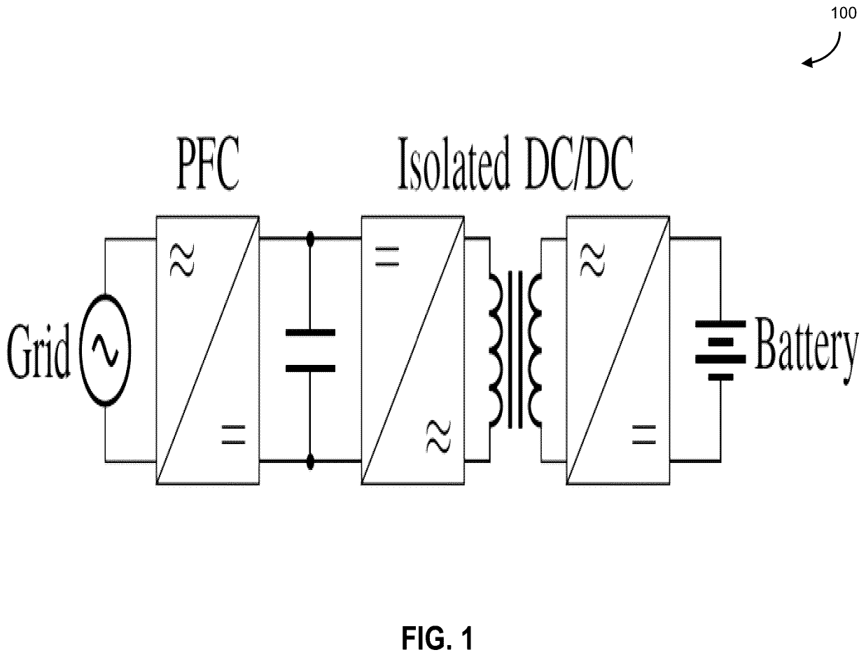

Onboard chargers (OBCs) are comprised of many parts, given their multi-stage topology. A typical OBC implementation consists of a PFC stage, followed by an isolated dc/dc converter 100, as shown in FIG. 1. As a result, OBCs tend to have relevant cost and mass, and savings on the topology can materially impact the overall vehicle.

One of the methods leveraged by researchers to reduce converter cost and mass is integration. This approach consists of leveraging pre-existing parts of the vehicle to implement the OBC, thereby eliminating, or at least reducing, the OBC's contribution to the vehicle's production cost and weight. In particular, the proposed controller can remove the necessity of a large electrolytic capacitor to process the second harmonic power ripple, furthering the main goal of integration, which is component cost reduction.

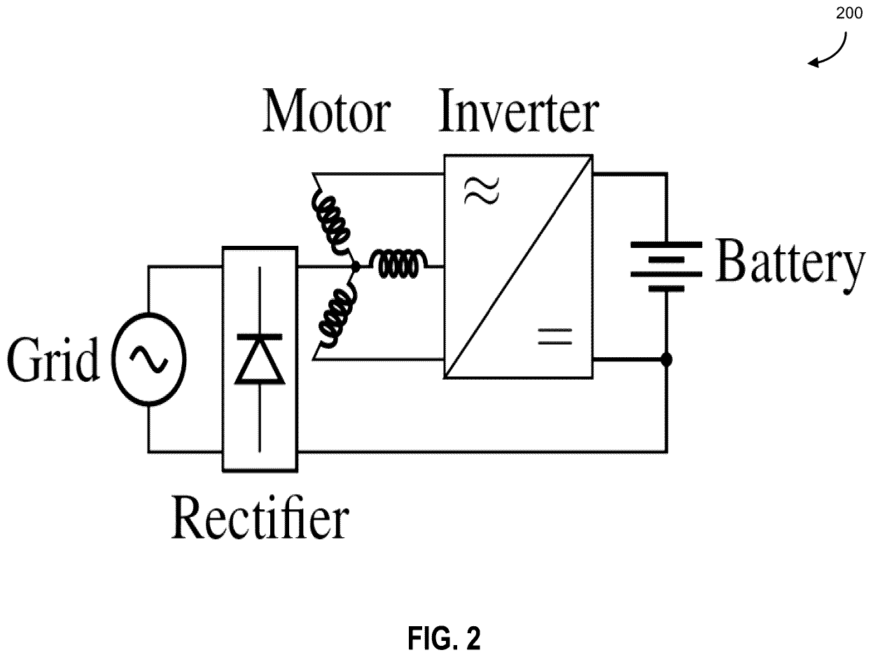

In an illustrative example, a charger is proposed that interfaces the ac grid via a rectifier, whose output is connected to the neutral point of the vehicle's wye connected motor. This connection leverages the zero-sequence inductance of the motor as the charger's filter. In conjunction with the rectifier, the traction inverter can control the power flow, implementing a PFC boost. The resulting system 200 is shown in FIG. 2.

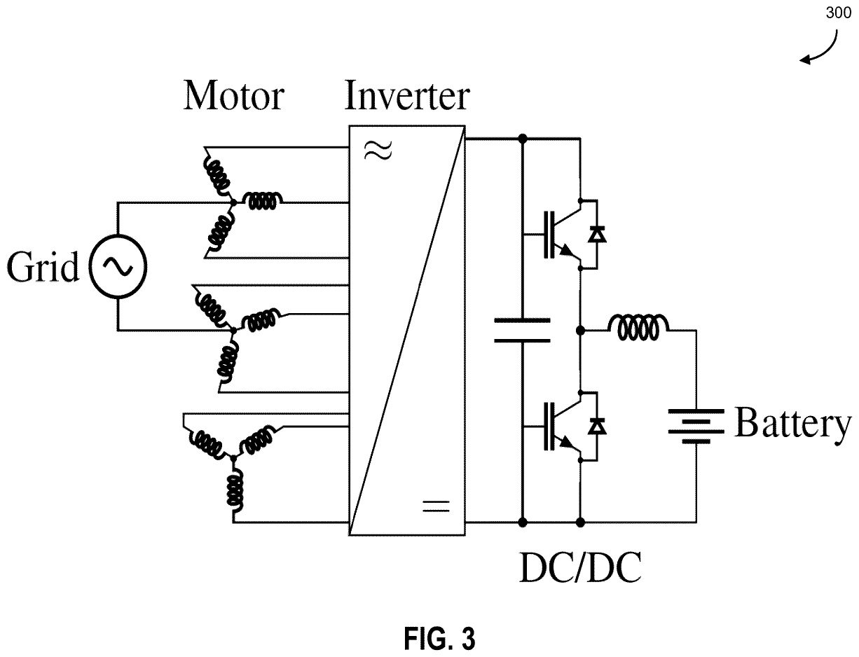

Implementations are also proposed using multiphase machines that have multiple neutral points or can be reconfigured to do so. In an illustrative example, a nine-phase machine with three sets of windings is used to charge from a three-phase or single-phase grid, with the latter shown as 300 in FIG. 3.

A similar configuration can be achieved using a six-leg inverter driving a split-phase machine. Different solutions are also discussed for different machine phase structures. These solutions create an extra degree of freedom associated with a current that does not produce torque, which would be undesirable during stationary charging. Another method of implementing a non-torque producing degree of freedom is to leverage a split-winding three-phase machine. In such configurations, each machine phase is split into two windings, through which current can be conducted.

In prior art approaches, a DC/DC converter is often required in many situations, and this DC/DC converter is required in situations where, for example, a 400V battery needs to be boosted to 800V. As described herein, a proposed approach is utilized to avoid the need for the DC/DC converter stage. Modulation is utilized to keep nuisance tripping aspects reduced as well.

Approaches have been considered, indicating how the same hardware can, by executing a different control software, be used for driving and charging. Like the topologies using neutral point connections, split-phase-based chargers allow the leakage inductance of the machine to be leveraged for filtering purposes while ensuring the charging current produces net zero flux through the rotor.

In the context of single-phase chargers, as in other single phase ac/dc applications, fluctuating second harmonic power can pose issues during operation. In this context, this power component is transmitted to the dc port, the vehicle battery, at twice the line frequency while producing zero charging effects. This power ripple leads to increased losses and heat production in the battery and may affect power quality measures, including current total harmonic distortion (THD) on the grid currents.

The classical solution to second harmonic power ripple, widely used in photovoltaic and uninterruptible power supply applications, consists of including a large electrolytic capacitor at the dc link, which is responsible for sinking the power ripple and limiting voltage fluctuation. Given the battery impedance levels, this solution is not usually feasible for EV applications, where an approach is, by control design, to route the second harmonic power ripple to the intermediary dc-link capacitor in multi-stage topologies. However, either solution, as a result of large passive components or multiple stages, increases total converter size and cost.

When high power density and long lifespan need to be achieved, it is necessary to address the problem in a cost and weight-effective manner, at the expense of control complexity. In such cases, active power decoupling (APD) strategies are employed. This alternative approach includes an energy storage component, typically a capacitor or inductor, in the system and the associated circuitry to control the power to said component. The strategy has been addressed in the EV charging context by introducing an extra stage to the OBC, or by requiring additional functionality of the vehicle's dc/dc converter.

APD approaches are challenging to control. In particular, in some proposed approaches herein, a specific control approach is disclosed that is less challenging, for example, the proposed approach of some embodiments does not be constrained to feed-forward and it ensures zero error.

Other approaches utilize feed forward schemes to calculate the power that is input, and attempt to predict the power of the second harmonic ripple and try to compensate for the ripple. However, a drawback with these other approaches is that it is difficult to ensure that there is zero second harmonic ripple as defining zero second harmonic ripple is challenging. Feedback techniques using linear time invariant systems are typically not available, given that the quantity to be zeroed, i.e., the SPHR, and the quantity to be actuated to zero the SHPR, e.g., the capacitor voltage are at different frequencies. Linear time invariant systems are incapable of producing an output at grid frequency, e.g., capacitor voltage, from an input at double line frequency, such as the SHPR.

Compared to these approaches, a benefit of the proposed controller is that it provides/maps the second harmonic ripple into a DC quantity that can be specifically checked whether it is 0 or whether it is +/− so that one can guide it (e.g., path to make it 0), and the way it does this by mathematically modelling it into a scalar DC quantity. Linear time invariant techniques, such as a PI controller, then can be used to produce a DC quantity that is indicative of the capacitor voltage, which can then be converter into line frequency using the Park transformation.

The feedback approach proposed above is superior to feed forward in some scenarios. In the feedback approach, the system observes the effect and then corrects the approach. Feedback is a valuable tool to allow the system to attain 0 second harmonic ripple.

While a plurality of approaches have been proposed in alternate approaches, ideal approaches would have a) zero average energy stored in the passive storage component during operation, minimizing peak energy rating, b) minimum added active circuitry and sensors, minimizing additional cost, and c) a closed-loop feedback control to maximize the efficacy of APD action. Accordingly, a topology that implements a single phase charger integrated into the drivetrain in proposed in a number of variations herein.

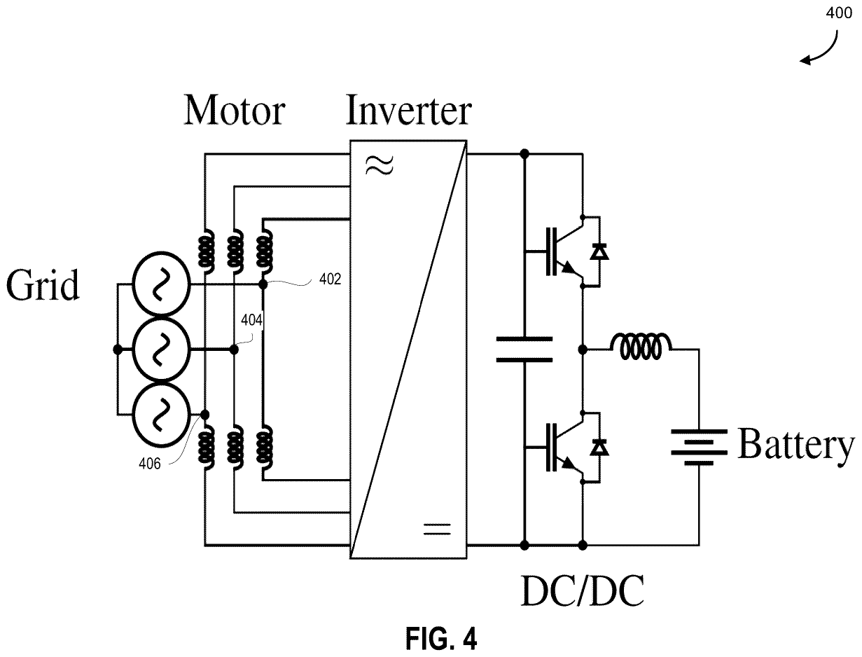

The drivetrain in this context is assumed to operate with an open winding split-phase machine which could be either an induction or synchronous machine, such as the one shown at 400 in FIG. 4.

In FIG. 4, it is important to note the “split phase” connection points at connection nodes 402, 404, and 406. 402, 404, and 406 split the coils into a top/bottom, or a first/a second coil. Two coils surrounding the same magnetic core structure (in a way that the flux linkage path for both coils face the same magnetic reluctance), having the extremity of each coil connected to one another may, in some cases, be defined as a split-phase coil, with the connection between both coils being the split-phase connection point.

Variations are possible—the coil can be further subdivided, for example, instead of a singular coil being split, multiple coils can be used in parallel and split, etc.

The connection nodes 402, 404, and 406 are shown to connect to the AC grid, but this is not absolutely necessary for every embodiment. Variations can include feeding a three-phase component from the split-phase connections, for instance. Examples of components fed by split-phase connections could be a single-phase or a three-phase load external to and fed by the vehicle, in a V2X application.

Adding in the connection nodes 402, 404, and 406 increases cost and complexity, but Applicants propose that this cost and complexity is worth a technical trade-off as the proposed approaches herein can be used to avoid to add other components to the system, thus saving more than is being added by the incremental cost of incorporating the connection nodes 402, 404, and 406.

Accordingly, a technical benefit is that the system does not add significant components or adds no hardware components to the drivetrain and can, for example, achieve single-phase charging with APD via a novel control strategy, which is enabled by introducing the power phasor approach and related mechanisms. The APD can be conducted, for example, by coupling control circuitry to the drivetrain. APD is optional in some embodiments, and the split phase control can be used independently to improve the functioning of the fast charger.

The system can be operated indistinguishably with one dc link, as in FIG. 4, or two dc links, leveraging a dual inverter topology.

As a drivetrain solution, the dual inverter has several advantages. This topology provides redundancy, allowing, in some cases, the system to operate at a limited capacity after the occurrence of faults and it can prove to be beneficial in applications with a wide speed range. Lastly, this topology can achieve low current ripple and increased power efficiency.

The technical contributions of this approach can be summarized as the 1) introduction and elaboration of the rotating power dynamic (time-varying) phasor approach, 2) proposition of a feedback control system for APD, using the power phasor approach, and 3) proposition of a single-phase charger using the APD mentioned above control system.

Compatible drivetrain solutions are introduced that can be suitable for implementing the single-phase charger introduced in this work, both using split-phase machines. It is important to note that other variations are possible.

These variations can include:

Motors-Number of Phases: three-phase or multiphase, with only three-phases used for charging.

Motor-Topology: Induction, Switched Reluctance, Synchronous Reluctance, Wound Rotor Synchronous Motor, Permanent Magnet Synchronous Motors.

### Energy-Storage: Single or Plural.

Number of Inverters: It can be two or more inverters. Considering split-phase coils for each phase of the machine, the winding sections can be many, all connected in one point, which may be connected to the grid. With “n” winding sections, there can be “n” inverters.

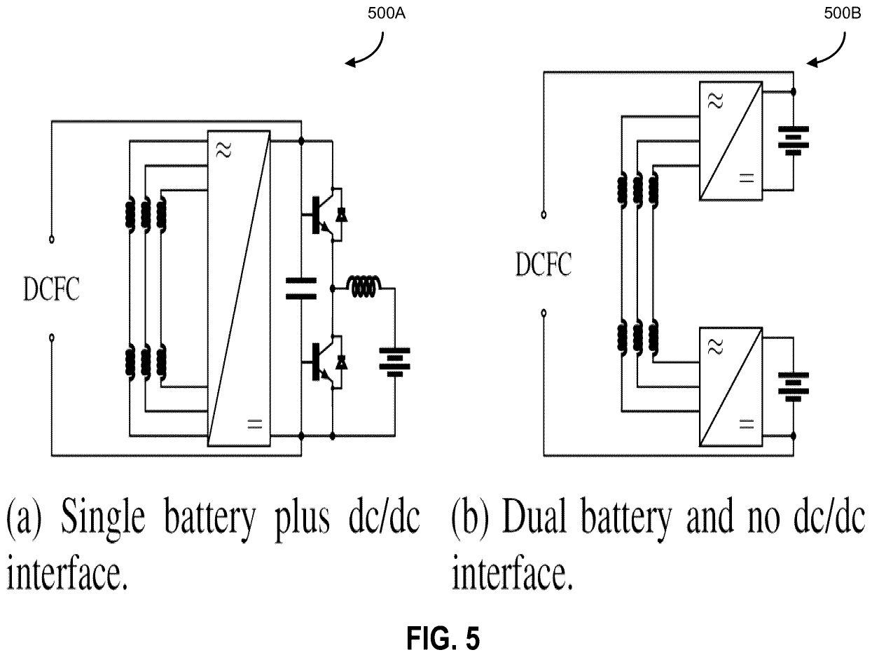

The first drivetrain topology 500A uses a single battery with an interfacing boost (viewed from the battery to the machine), shown in FIG. 5 at (a). In this topology, the boost interface can maintain the dc-link voltage regardless of the battery's state of charge. Moreover, the boost converter regulates the dc-link voltage, enabling the connection to do fast chargers designed for 400 V or 800 V battery technologies. On the other hand, the boost converter adds complexity and introduces a bulky inductor, given the high current specification required by the driving operation. The minimum link voltage is a consideration. This is lower for single phase than three phase charging.

For conventional 800 V systems, charging from legacy 400 V charging stations can be enabled by the inclusion of a boost-converter, which boosts the 400 V from the charger, making it suitable for the 800 V battery. However, the boosting stage is expensive owing in part to the expensive inductor included within.

In contrast, the proposed topology does not need a dedicated boost, instead allowing for the output of the 400 V charger to be connected directly to two of the split-phase connection points. The machine inductance and traction inverters then form the boosting stage without any additional component cost.

The second compatible drivetrain topology 500B is the dual inverter drivetrain, shown in FIG. 5 as shown at (b). This approach enables the operation of the machine with higher voltages even during low state-of-charge operation. Moreover, this topology inherently enables interfacing dc fast chargers designed for 400 V or 800 V battery technologies.

While the dual inverter topology has the drawback of requiring two separate batteries, potentially adding complexity to the battery management system, the added mass and cost to the vehicle may be less than what would be added by the boost inductor. In the remainder of this section of the disclosure, the dual inverter is assumed for the mathematical formulation, simulation, and experimental verification. However, the results can be extrapolated to the single-battery topology. The operation of the dual inverter with dual batteries can be described as two parallel rectifiers, each feeding a distinct battery. However, the fact that the batteries are distinct does not have any significant bearing on the operation. The two batteries could be the same, single battery, connected to two distinct inverters. The inverters would, then, control the power delivered to the battery, with each inverter controlling the power flowing to itself.

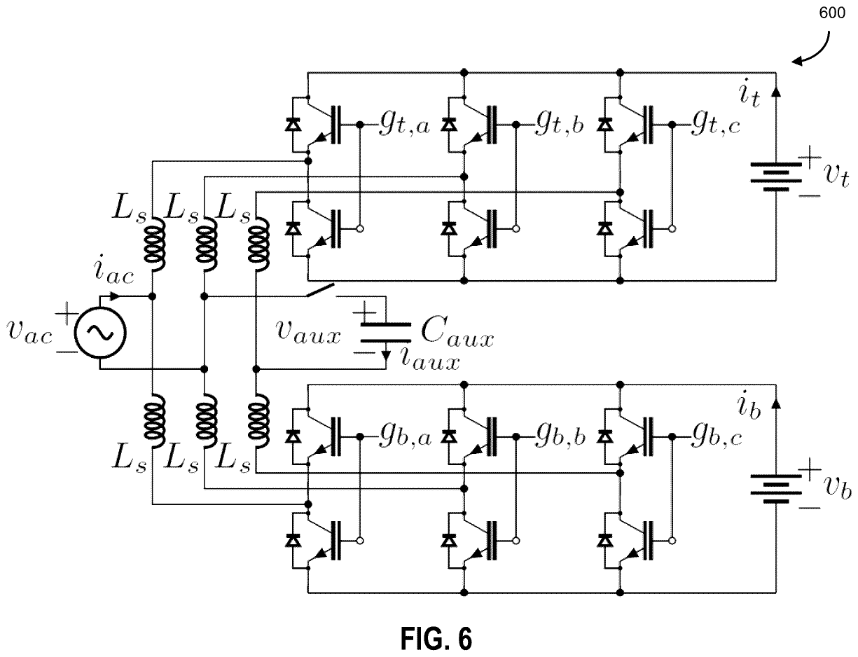

A proposed topology is now introduced based on a drivetrain architecture driving an open-winding split-phase machine. The windings are used to interface the ac grid, which connects to the machine's center point of two different phases. APD functionality can be enabled by an auxiliary capacitor connected to the third phase, as shown in FIG. 6, but this is optional and present on some embodiments. Another variation uses an auxiliary inductor instead. The system 600 represented in FIG. 6 operates similarly to a pair of voltage source inverters (VSIs), connected to the same ac voltage source, each one of which has its dc voltage source. The third half-bridge, present in each VSI, connects an additional APD storage capacitor and the extra leg voltage can be modulated accordingly. Lastly, given the machine symmetry, if, for each machine phase, identical currents flow through the top and bottom inverters, a net-zero flux is generated through the rotor, ensuring zero torque production. A separate switch, from the inverter can be used to connect the auxiliary capacitor/inductor.

This section examines the second harmonic power ripple flowing into the de links of the two VSIs shown in FIG. 6. For this objective, it is helpful to, initially, analyze the system operating without the auxiliary capacitor/inductor and, therefore, without any active power decoupling. Variations providing APD utilize either an auxiliary capacitor or an auxiliary inductor.

The ac grid voltage can be defined as:

$${v}_{ac} ( t ) = {\hat{v}}_{ac} cos ( ω t ) ,$$

where \hat{V}_{ac} is the magnitude of the grid voltage, a slow varying as a function of time, in comparison to the grid frequency ω. An oscillator is presented in the appendix below that is capable of practically computing the time-varying phasor, i.e., the analytic signal, associated with any sinusoidal signal. With this tool, it is possible to compute \vec{V}_{ac}=(\hat{V}_{ac})e^{jωt}, where the real component of this dynamic phasor is the waveform defined in (1); i.e. V_{ac}(t)= [symbol] (\vec{V}_{ac})

The grid current can be represented as:

$${i}_{ac} ( t ) = {\hat{i}}_{ac} cos ( ω t + {θ}_{i} ( t ) ) ,$$

where both the current magnitude, î_{ac}, and phase θᵢ, are slow varying signals. Its dynamic phasor may again be computed using the oscillator of the appendix and is given by:

$${\vec{i}}_{ac} = ( {\hat{i}}_{ac} {∠θ}_{i} ) {e}^{j ω t}$$

The instantaneous power extracted from the grid, resulting from the multiplication of the grid voltage and current, can be described as

$$\begin{matrix}{p}_{ac} ( t ) = {i}_{ac} ( t ) {v}_{ac} ( t ) \\ = \frac{1}{2} {\hat{v}}_{ac} {\hat{i}}_{ac} cos ( {θ}_{i} ) + \frac{1}{2} {\hat{v}}_{ac} {\hat{i}}_{ac} cos ( 2 ω t + {θ}_{i} )\end{matrix}$$

In terms of dynamic phasors, this power can be written as

$${p}_{ac} ( t ) = \text{?} ( \frac{1}{2} {\vec{v}}_{ac} {\vec{i}}_{ac}^{*} + \frac{1}{2} {\vec{v}}_{ac} {\vec{i}}_{ac} )$$

The first term, S_{ac}, is constant in steady state and describes the widely used complex power concept for single-phase applications,

$${S}_{ac} = \frac{1}{2} {\vec{v}}_{ac} {\vec{i}}_{ac}^{*} = {P}_{ac} + {jQ}_{ac} = \frac{1}{2} {\hat{v}}_{ac} ( {\hat{i}}_{ac} ∠ - {θ}_{i} ) {e}^{j 0 ω t}$$

The second term, termed \vec{r}_{ac}, describes the rotating power dynamic phasor, a concept introduced in this work. It can be written as

$${\vec{r}}_{ac} = \frac{1}{2} {\vec{v}}_{ac} {\vec{i}}_{ac} = {r}_{ac , α} + {jr}_{ac , β} = \frac{1}{2} {\hat{v}}_{ac} ( {\hat{i}}_{ac} {∠θ}_{i} ) {e}^{j 2 ω t}$$

and describes the power component that rotates at twice the grid frequency, determining the second harmonic power ripple flowing from the grid.

As with other dynamic phasors, the underlying power ripple is [symbol] (\vec{r}_{ac}).

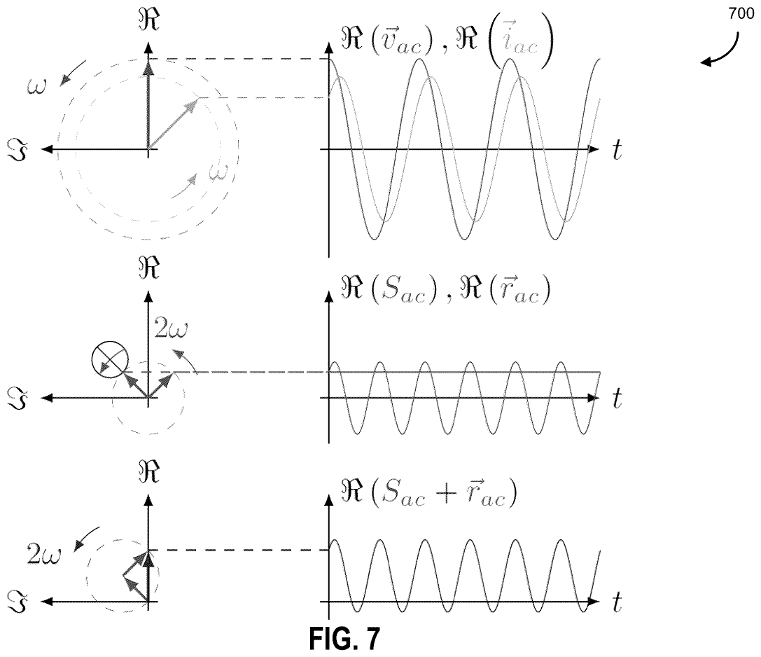

FIG. 7 provides a graphical illustration 700 of the phasor diagram associated with \vec{r}_{ac}. In FIG. 7, the voltage and current phasors rotate at w. The apparent power, S_{ac}, is stationary, while \vec{r}_{ac} rotates at twice the grid frequency, as implied by the above equation.

As indicated in the above equation relating to instantaneous power, the instantaneous active power can be computed as the real part of the sum of both components. A portion of this rotating power is stored in, and released from, the interface inductance connecting the grid and the inverter. Given the connection structure and definitions laid out in

FIG. 6, the interface inductance is defined by the machine leakage inductance Lₛ. The phasor power consumed by the interface inductance is described by:

$${\vec{r}}_{L} = \frac{1}{2} j ω {{L}_{s} ( {\vec{i}}_{ac} )}^{2}$$

The power flowing through the output ports of the converter, i.e. the dc links, is the difference between the input ac power and the power consumed by the interface inductance,

$${p}_{out} ( t ) = {P}_{ac} + \text{?} ( {\vec{r}}_{ac} - {\vec{r}}_{L} )$$

The undesired second harmonic power ripple phasor flowing to the output of the converter is given by \vec{r}ₒᵤₜ=\vec{r}_{ac}−\vec{r}_{L}

Evaluating the above and, without loss of generality, assuming θᵢ=0, yields

$${\vec{r}}_{out} = ( \frac{1}{2} {\hat{v}}_{ac} {\hat{i}}_{ac} - j ω {L}_{s} \frac{1}{2} {\hat{i}}_{ac}^{2} ) {e}^{j 2 ω t}$$

An αβ-to-dq transformation can be applied to the output power to get the representation in rotating reference frame (RRF). Note that, differently from what is defined for grid-side voltages and currents, the power reference frame rotates at twice the grid frequency, and as a result, the transformation must use the angle 2ωt, i.e., twice the grid angle.

$$\begin{matrix}{\vec{r}}_{out , dq} = {r}_{out , d} + {jr}_{out , q} \\ = {\vec{r}}_{out} {e}^{- j 2 ω t} \\ = \frac{1}{2} {\hat{v}}_{ac} {\hat{i}}_{ac} - j ω {L}_{s} \frac{1}{2} {\hat{i}}_{ac}^{2}\end{matrix}$$

To provide illustration regarding the meaning of the direct and quadrature axis on the RRF used for power quantities, consider the evaluation of the output power as a function of time,

$${p}_{out} ( t ) = \frac{1}{2} {\hat{v}}_{ac} {\hat{i}}_{ac} + \frac{1}{2} {\hat{v}}_{ac} {\hat{i}}_{ac} cos ( 2 ω t ) + \frac{1}{2} ω {L}_{s} {\hat{i}}_{ac}^{2} sin ( 2 ω t ) .$$

Matching the coefficients of the above two equations, illustrates the meaning of the representation, where the d-axis,

$${r}_{out , d} = \frac{1}{2} {\hat{v}}_{ac} {\hat{i}}_{ac}$$

is the coefficient associated with cos (2ωt), a component whose peaks are in phase with the peaks (and valleys) of the grid voltage, whereas the q-axis,

$${r}_{out , q} = - \frac{1}{2} ω {L}_{s} {\hat{i}}_{ac}^{2}$$

is the coefficient associated with −sin (2ωt), a component whose peaks occur when ωt=−π/4 (and ωt=3π/4).

Active Power Decoupling (APD) is described below.

With the inclusion of the auxiliary capacitor for power decoupling, the output power phasor, describing the second harmonic power ripple delivered to the batteries becomes

$${\vec{r}}_{out} = {\vec{r}}_{ac} - {\vec{r}}_{L} - {\vec{r}}_{aux}$$

as the power delivered to the auxiliary capacitor, \vec{r}ₐᵤₓ, also subtracts from the input power from the grid.

The auxiliary capacitor power is determined as a function of the capacitor voltage \vec{V}ₐᵤₓ.

$${\vec{r}}_{aux} = \frac{1}{2} j ω {{C}_{aux} ( {\vec{v}}_{aux} )}^{2} = \frac{1}{2} j ω {{C}_{aux} ( {\hat{v}}_{aux} {e}^{j {θ}_{aux}} )}^{2} {e}^{j 2 ω t}$$

where \hat{V}ₐᵤₓ and θₐᵤₓ are, respectively, the magnitude and phase of the voltage applied to the capacitor.

$${\vec{r}}_{aux , dq} = \frac{1}{2} j ω {{C}_{aux} ( {\vec{v}}_{aux , dq} )}^{2}$$

Note that the APD strategy consists of, by choice of an appropriate \vec{V}ₐᵤₓ, delivering a value of \vec{r}ₐᵤₓ which ensures \vec{r}ₒᵤₜ=0.

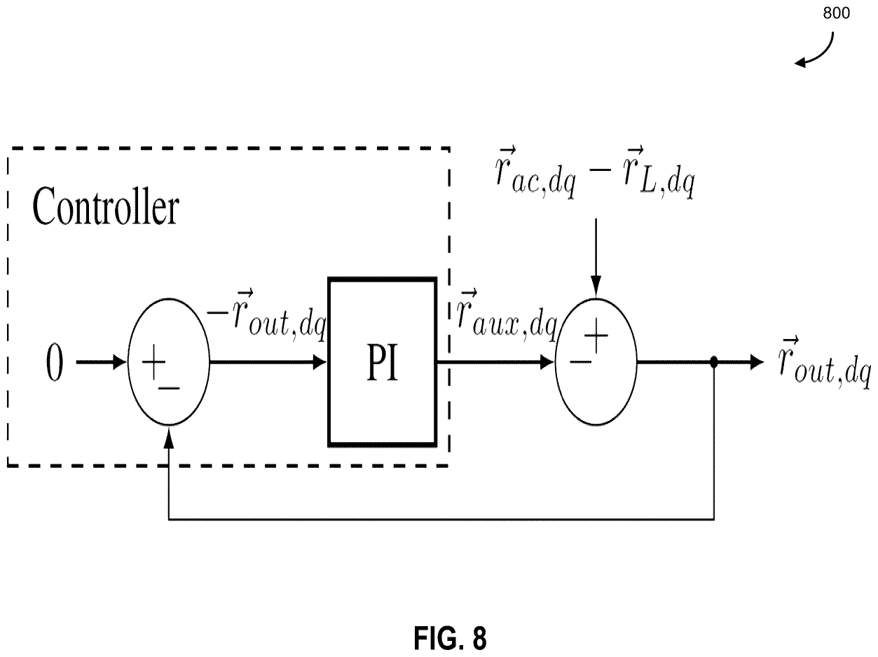

A simplified representation of the APD control loop 800 is represented in FIG. 8.

The following section describes a proposed control approach.

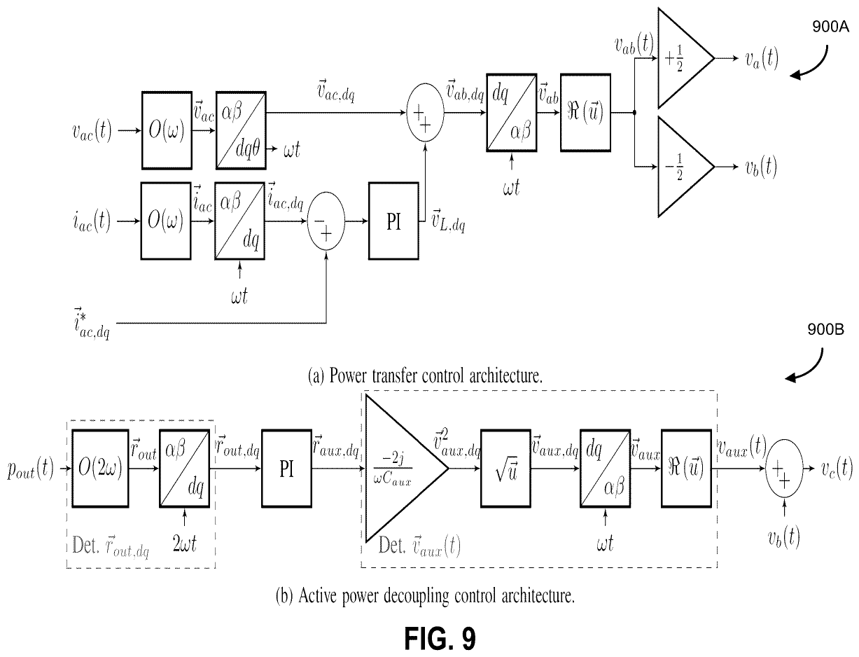

The proposed control strategy is comprised of two conceptually and functionally independent sub-architectures 900A and 900B, as shown in FIG. 9. 900A shows an example power transfer control architecture. 900B shows an example power decoupling control architecture.

The first architecture controls the average power transfer between the grid and the battery by ensuring that the grid current follows an arbitrary reference. A supervisory control may be added to the system to set the grid current reference based on specific active and reactive power objectives. The second architecture is responsible for attenuating the second harmonic power ripple flowing to the two batteries.

The power transfer control architecture, shown in FIG. 9 at portion (a), applies the oscillator described in appendix to compute the phasor of the grid current and voltages. The grid voltage phasor is processed by the block that calculates its angle, ωt, and converts the voltage to RRF, using wt as a reference.

The grid current phasor is rotated using the Park transformation with reference equal to ωt, generating the RRF dq representation of the current. A current reference is provided for the d-axis and q-axis, the former responsible for active power transfer, whereas the latter is responsible for reactive power.

The current tracking error is fed into a PI controller in each axis. The output of the PI controller signifies the voltage in RRF to be applied to the interfacing inductor, i.e., leakage inductances of the machine. Therefore, the grid voltage needs to be fed forward to determine the voltage, in dq frame, which the circuit must synthesize and apply between phases “a” and “b”, \vec{V}_{ab,dq}, to oppose the grid voltage.

This voltage is rotated back into the stationary reference frame (SRF) using the grid angle, and the real part is sent to the PWM modulator.

A simplified representation of the APD controller can be understood as a system that measures the value of \vec{r}_{out,dq} and compares it to a reference of 0. The system then applies a PI controller, which determines the value of aux dq that must be imposed in order to zero \vec{r}_{out,dq}. In doing so, the system effectively cancels the unmeasured disturbance \vec{r}_{ac,dq}−\vec{r}_{L,dq}, described in the equation describing the second harmonic power ripple delivered to the batteries above. A simplified representation of the controller is shown in FIG. 8. Note that either \vec{r}_{out,dq} or −\vec{r}_{out,dq} suffice as the input to the PI.

To enact this control system, two key considerations, stemming from the oscillator and the power phasor representation, are exploited:
1. the determination of \vec{r}_{out,dq} from the measured power flowing to the battery, pout(t), where pout(t)=−pₜ−p_{b}=−vₜiₜ−v_{b}i_{b}: observing the active sign convention, and
2. the determination of vₐᵤₓ(t) to be applied to the capacitor, from the power \vec{r}_{aux,dq}, which can be found by solving for \vec{v}_{aux,dq}, rotating it back to SRF, aux, da, and taking the real component. The exact implementation is shown in FIG. 9 at (b). Once the desired vₐᵤₓ(t) to be applied by the modulator is defined, this value is added to v_{b}(t), defined by the grid power control loop. This is because vₐᵤₓ(t)≈v_{c}(t)−v_{b}(t).

The implementation shown in FIG. 9(b) shows the triangular gain block for didactic purposes only. In practical applications, for simplicity of implementation, the factor 2/(ωC) can be incorporated into the PI controller.

In contrast, the −j factor can be incorporated by using the angle ωt-π/4, instead of the wt shown in FIG. 9(b), on the downstream dq-to-αβ transformation.

Simulations are described in this section.

The circuit described in FIG. 6 is used to construct simulations as well as an experimental setup to verify the proposed system's functionality. The parameters used in simulations are shown in Table I.

TABLE I
Parameters used in simulation In the first simulation based
test, the system operates in grid-to-vehicle mode, with
the grid providing 20 A with unity power factor.

| Parameter | Description | Value | |
|---|---|---|---|
| vₜ | Battery voltage | 400 | V |
| v_{b} | Battery voltage | 400 | V |
| v_{ac} | Grid voltage | 120 | Vrms |
| f_{sw} | Switching frequency | 10 | kHz |
| Cₐᵤₓ | Auxiliary Capacitance | 600 | μF |
| Lₛ | Machine Leakage Inductance | 2 | mH |
| Rₛ | Winding section resistance | 0.5 | Ω |

The active power decoupling controller is disabled for this test, and the auxiliary capacitor is disconnected from the system using the series switch. This configuration demonstrates charging functionality while making explicit the second harmonic power ripple issue faced by single-phase chargers.

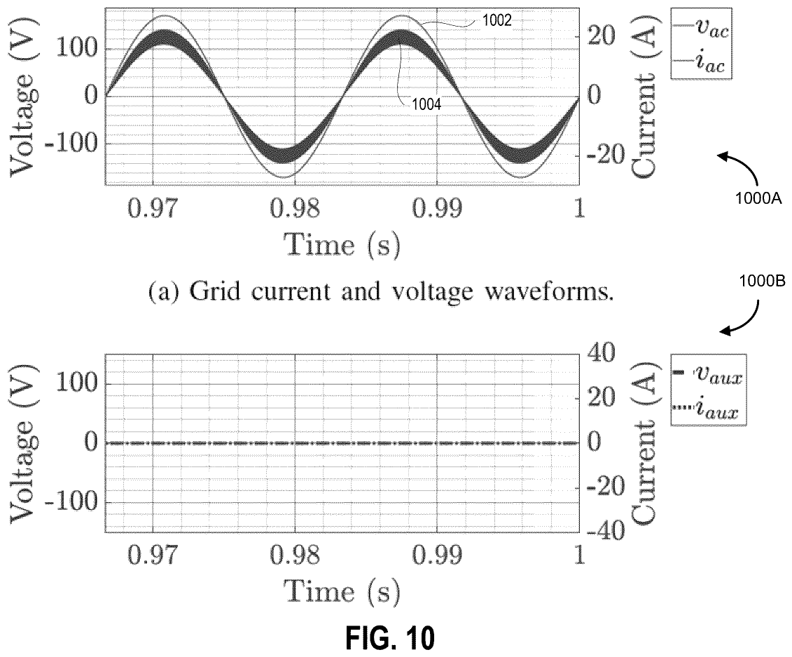

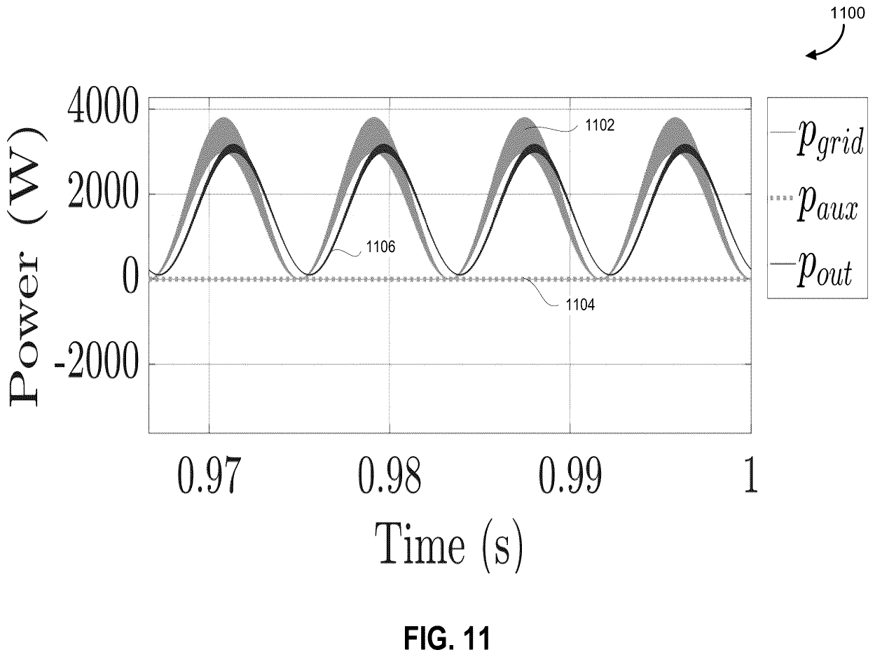

The results of this analysis are shown in FIG. 10, as it pertains to voltages and currents, and FIG. 11, as it pertains to power flow. FIG. 10(a) shows the voltage 1002 and current 1004 waveforms from the grid in graph 1000A, whereas FIG. 10(b) shows the voltage and current through the auxiliary capacitor in graph 1000B, both of which are identically zero since the system is disconnected.

The power flowing through the system is recorded during the same test. In FIG. 11, the instantaneous power from the grid, p_{grid} 1102, the power flowing into the auxiliary capacitor, pₐᵤₓ 1104, and the total power flowing into the top and bottom batteries, pₒᵤₜ 1106 is shown in graph 1100. A significant second harmonic component is observed in pₒᵤₜ, which is driven by the second harmonic power ripple from the grid, combined with the reactive power consumed by the winding leakage inductance.

The same system is tested with the active power decoupling controller enabled, in addition to the power controller.

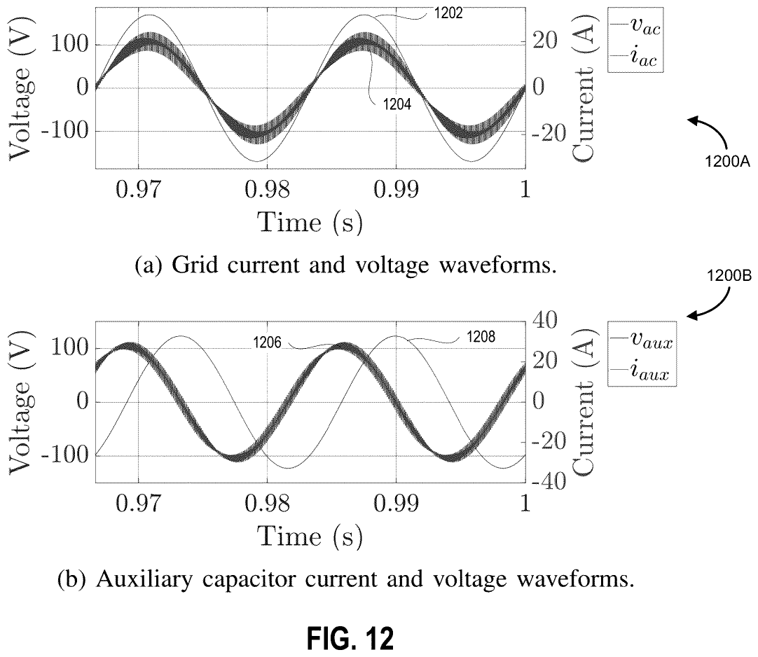

FIG. 12 shows in graphs 1200A and 1200B the waveforms generated by the test results.

The grid related voltage 1202 and current 1204 waveforms are shown in FIG. 12(a) and are sinusoidal and in phase, similarly to the previous case. The difference is in the auxiliary capacitor waveforms, which are controlled to cancel “rout. Sinusoidal current 1206 and voltage 1208 waveforms through the capacitor can be seen in FIG. 12(b). The active power decoupling controller forces the second harmonic ripple on the battery current and power to zero. As a result, the instantaneous output power is constant.

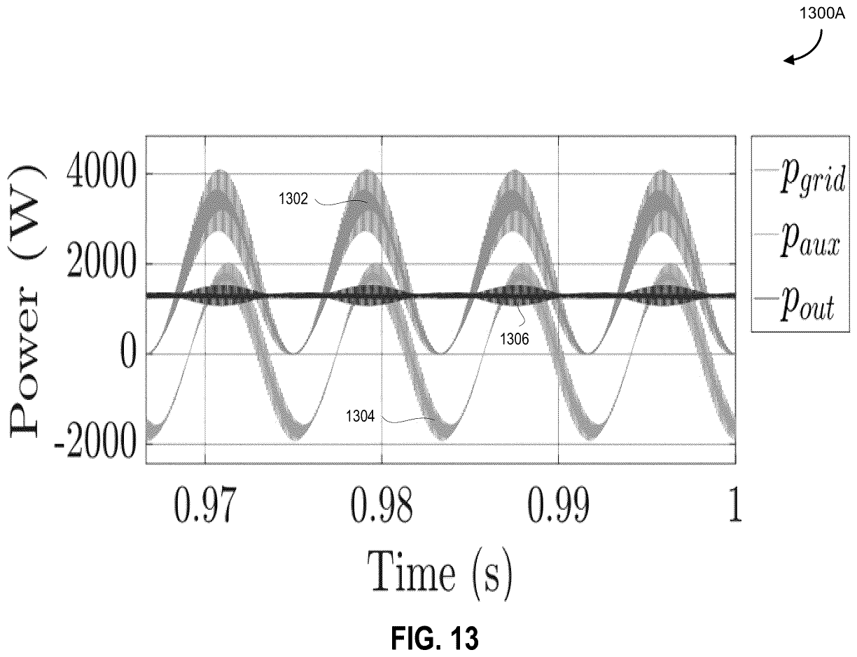

FIG. 13 shows the resulting instantaneous power in graph 1300, with p_{grid} 1302, pₐᵤₓ 1304, and pₒᵤₜ 1306. The main difference to the previous test is that this system has a second harmonic ripple flowing into the capacitor, which cancels the second harmonic ripple into the batteries via the APD feedback controller. The system is operated once more with the APD controller disabled to demonstrate transient performance. Here, a step is applied to the d-axis current reference, from 0 A to 20 A. As the step is applied, the grid current starts to increase.

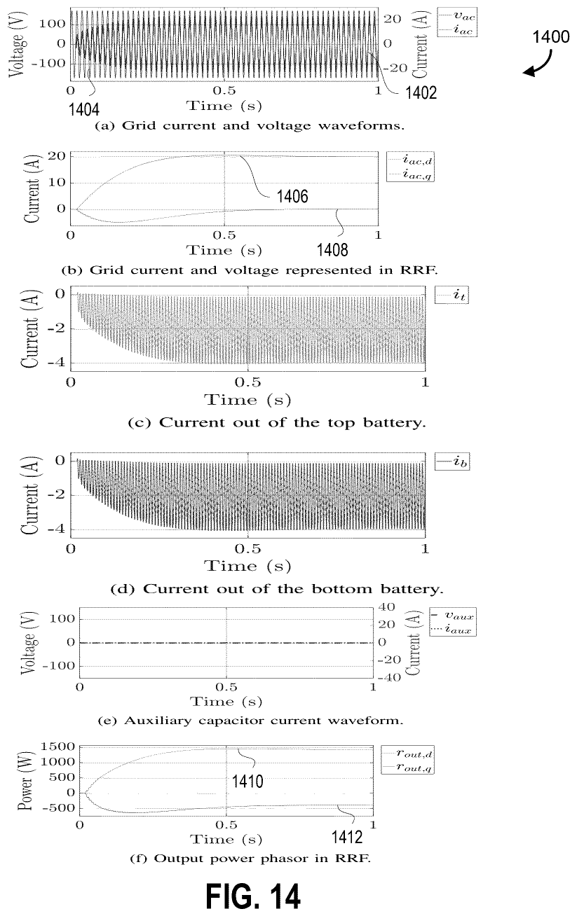

FIG. 14 is a set 1400 of graph trace diagrams showing a simulation of transient turn on of APD controller, according to some embodiments. The current 1402 is sinusoidal and in phase with the grid voltage 1404, as it can be observed in FIG. 14(a). The controller is implemented in RRF, as discussed in section V. The internal variables representing the dq axis of the grid current, i_{ac,d} 1406 and i_{ac,q} 1408 are shown in FIG. 14(b). The controller enforces the references of 0 A for the q-axis and 20 A, for the d-axis defining the grid current of 20 A at unity power factor. As the grid current increases, the current out of the batteries decreases, shown in FIG. 14(c) and FIG. 14(d). In these plots, as modeled in the equation for the power flowing through the output ports of the converter, i.e., the dc links, being the difference between the input ac power described above, the power into the battery can be seen to have a dc value, responsible for charging, and a second harmonic ripple, which increases the RMS value of the current into the battery, for a given charging power.

As mentioned before, the APD controller is disabled for this test, as the auxiliary capacitor is not driven. As a result, the current and voltage into the auxiliary capacitor are identically zero, as shown in FIG. 14(e). Even though the APD system is disconnected, the power ripple phasor in the dq-frame is computed for visualization purposes, leveraging the approach described above in relation to r_{out,d} and r_{out,q}.

The output power, as in FIG. 9(b), is fed into the oscillator, which attenuates the dc component and generates the power ripple phasor. This vector is rotated into the dq-frame, where the said ripple is dc. The resulting components are shown in FIG. 14(f), r_{out,d} 1410 and r_{out,q} 1412. The simulation is repeated with the APD controller enabled.

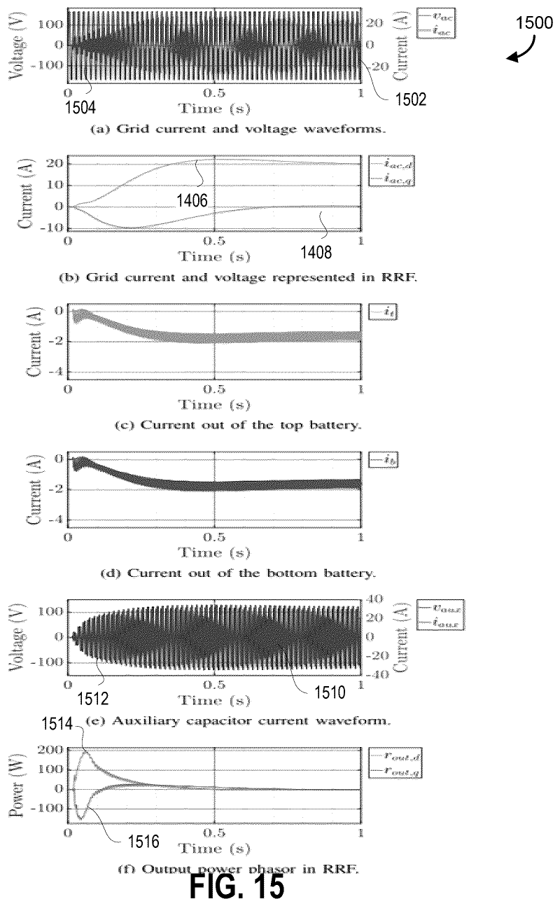

As in the previous case, the grid current increases in phase with the voltage as the step transient is applied. FIG. 15 is a set 1500 of graph trace diagrams showing a simulation of transient turn on of APD controller, according to some embodiments. FIG. 15(a) shows the grid current 1502 and voltage 1504 waveforms during the transient. The grid current waveforms, i_{ac,d} 1506 and i_{ac,q} 1508, rotated, by the controller, into RRF, are shown in FIG. 15(b). Once more, the power transfer controller is shown to operate satisfactorily, with the current following the pre-set reference. The first difference between the cases arises when observing the current out of the batteries. As the reference step is applied in this test, the battery current starts to rise. Simultaneously, the APD controller measures the second harmonic ripple and determines the appropriate voltage to be applied to the capacitor to zero the power fluctuation. As a result, the battery currents decrease, this time with no second harmonic ripple, as shown in FIG. 15(c) and FIG. 15(d).

To achieve APD, the auxiliary capacitor is driven as the appropriate power sink. The current 1510 and voltage 1512 across the capacitors are shown in FIG. 15(e). As the transient is applied, the capacitor voltage 1512 and current 1510 magnitudes grow until the system reaches a steady-state. Another way to visualize the control action is to observe FIG. 15(f), where the RRF representation of the output power ripple phasor is shown, with r_{out,d} 1514 and r_{out,q} 1516. As the system receives the current reference step, the ripple starts to rise, similarly to what happens in FIG. 14(f).

However, with the APD controller enabled, the inverter's “c” leg voltage is modulated to decrease both d and q components to 0.

Experimental results are described in the section below.

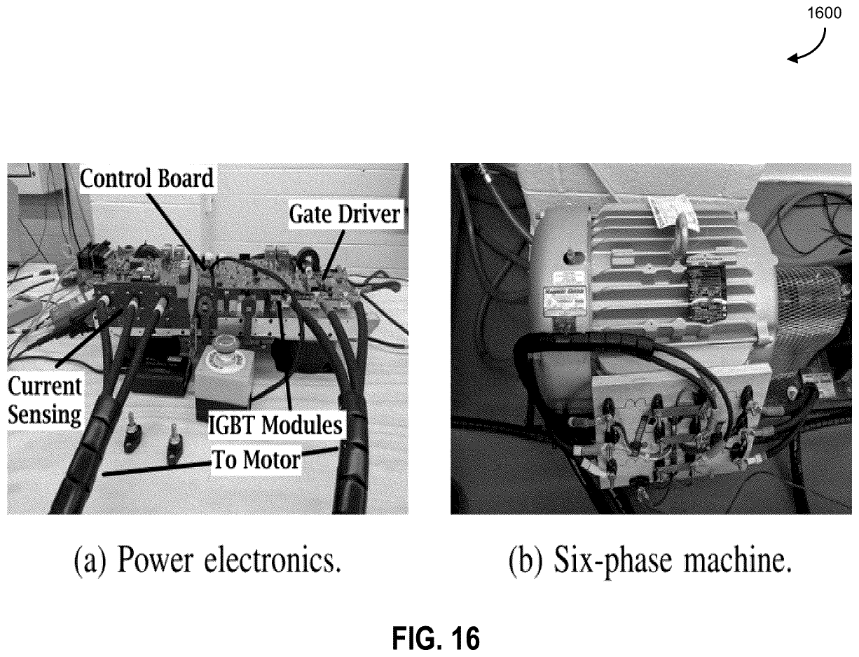

The system of FIG. 6 is implemented experimentally, as shown in FIG. 16. FIG. 16 is a depiction of an experimental setup 1600, according to some embodiments.

FIG. 16(a) shows the power electronic interface, including the control board, featuring a TI F28379D DSP and gate drivers. The open winding split-phase induction machine is shown in FIG. 16(b).

Two EA-PSB bidirectional power supplies emulate the dual battery pack. The tests discussed in this section are conducted with 120 Vᵣₘₛ grid at 20 A charging current, due to available machine rated power limitations. A full-scale system would typically operate at 240 Vᵣₘₛ and 30~60 Aᵣₘₛ.

The experimental verification has two objectives: demonstrate the steady-state operation of the system and showcase the transient performance during load changes.

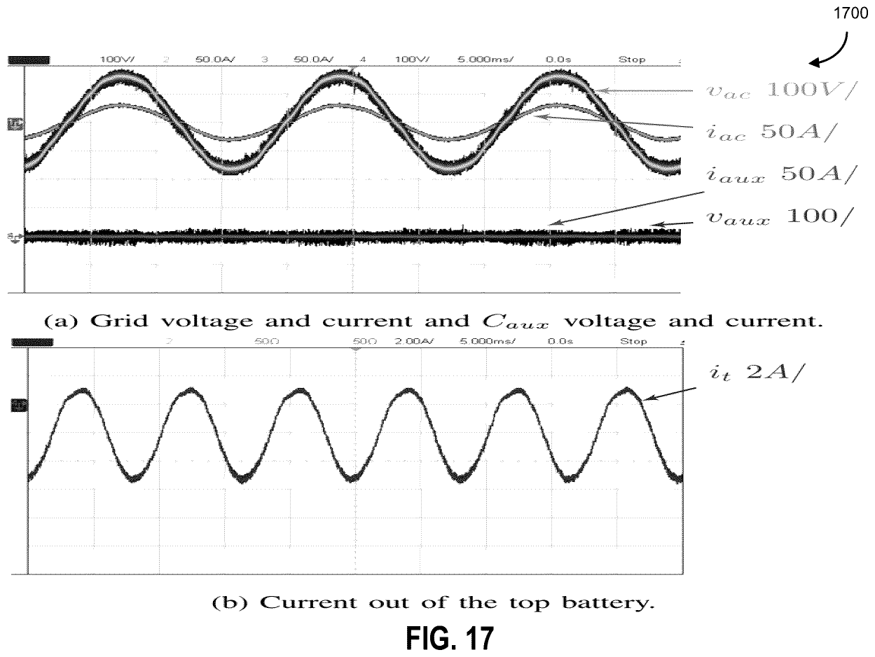

Moreover, the experimental results demonstrate the system's ability to operate with or without the APD controller enabled. To observe the system's performance in steady-state, it is operated with unity power factor and grid current l_{ac}=20 Arms. First, this operation is enacted with the APD system disabled. This test measures the grid voltage and current, the auxiliary capacitor voltage and current, and the top battery current. The result is shown in FIG. 17, a set 1700 of graph trace diagrams showing experimentally measured waveforms during single phase charging operation with active power decoupling controller disabled, according to some embodiments

With the reference power factor of 1, the grid current is controlled to be in phase with the grid voltage, as shown in FIG. 17(a). The auxiliary capacitor has zero current and voltage, as it is also shown in FIG. 17(a). Without the APD controller there is a significant second harmonic power ripple into the batteries.

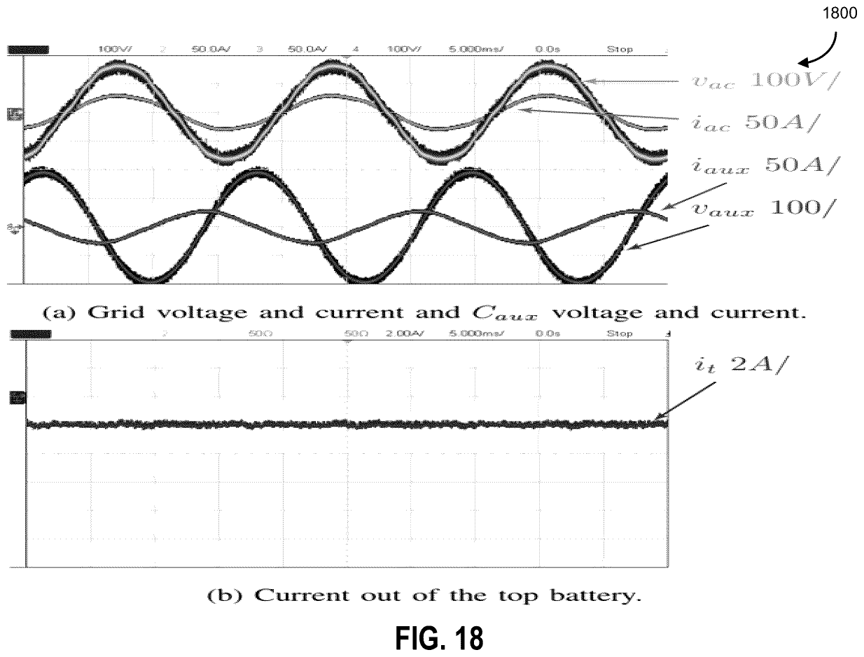

This effect is shown in FIG. 17(b) as a significant second harmonic current ripple through the dc source. The same test is conducted with the APD system enabled to showcase the proposed controller operation in steady-state. The results of this test are shown in a set 1800 of graph trace diagrams in FIG. 18. With the APD controller enabled, the grid voltage and current, shown in FIG. 18(a) are the same as shown in FIG. 17(a), suggesting that the introduced control does not disturb the regular power transfer operation.

However, now the auxiliary capacitor voltage and current are controlled to be sinusoidal, as shown in FIG. 18(a). Moreover, the control system sets the auxiliary capacitor voltage to cancel the second harmonic power ripple flowing through the batteries.

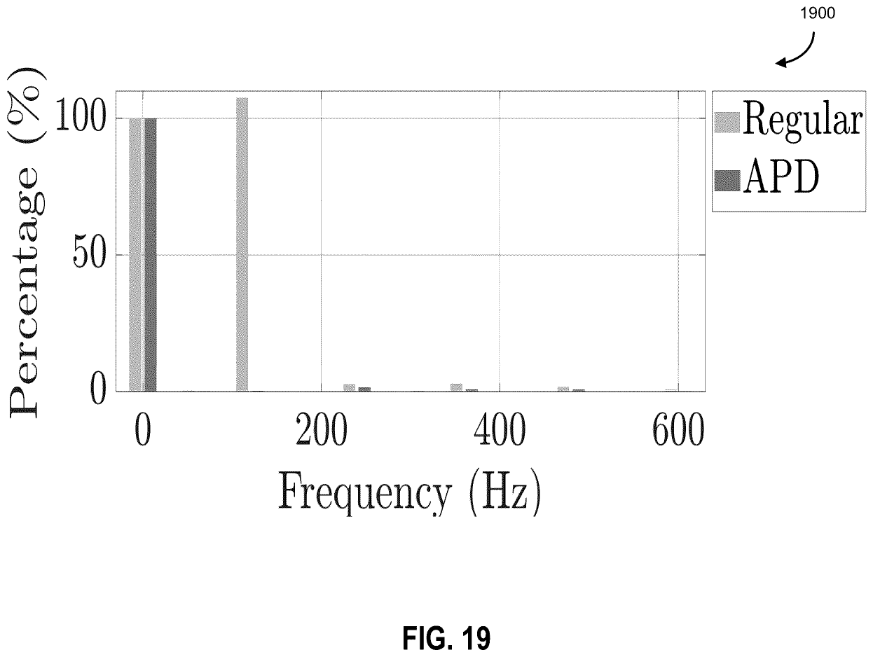

As a result, the current out of the top battery, shown in FIG. 18(b), has no visible second harmonic ripple component. To examine the extent of the second harmonic ripple mitigation, the data in FIG. 17(b) and FIG. 18(b) is post-processed. The current is decomposed into its frequency components for each case. FIG. 19 shows the results of the analysis. FIG. 19 is a set of graph trace diagrams 1900 showing experimentally measured harmonic content of current into the top battery during single-phase charging operation with active power decoupling controller disabled compared with analogous measurement made during operation with active power decoupling controller enabled, illustrative of simulation results, according to some embodiments.

In other words, the current into the auxiliary capacitor is meant to attenuate a harmonic component. The resulting current into the energy storage thus will have has less harmonics and thus the current is minimized or brought to zero.

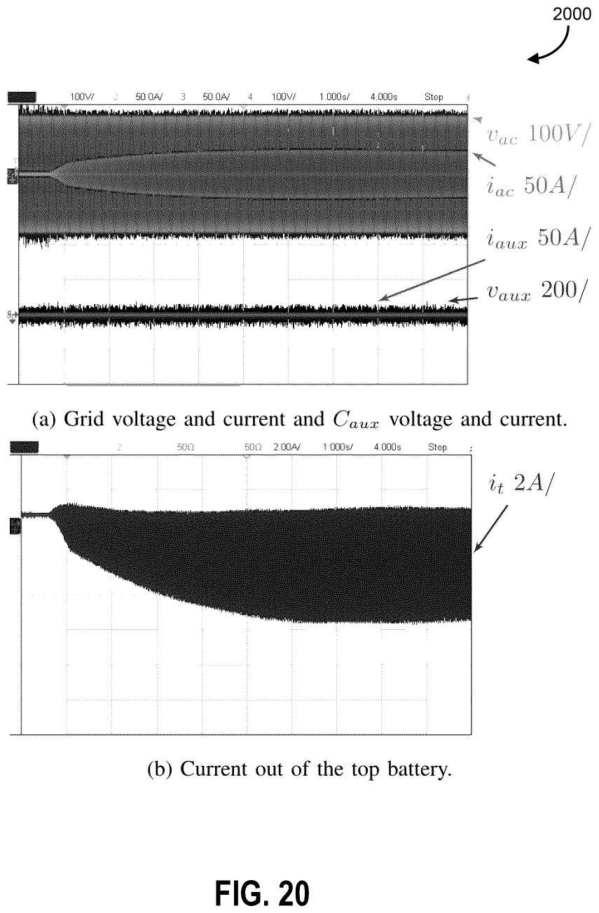

Operation without the APD controller has a second harmonic current ripple larger than the dc component. In comparison, operation with APD controller enabled reduced ripple magnitude by 99.7%, with residual ripple presumably the result of the oscilloscope and DSP measurement mismatches. To investigate the system impact during transients, the charger is operated during a charging ramp up, from 0 to 20 Arms grid current at unity power factor. First, the system is subjected to this transient with the APD controller disabled. The results are shown in FIG. 20, a set 2000 of graph trace diagrams showing experimentally measured waveforms during single phase charging operation with active power decoupling controller disabled, according to some embodiments. As the step is applied to the reference current, the system increases the grid current, as shown in FIG. 20(a).

The auxiliary capacitor currents and voltages remain at 0, as the APD controller is disabled in this first experiment. With no power decoupling, the battery's ripple power and ripple current increase.

This effect is seen in FIG. 20(b), where the current displays a negative dc value after the load step, since it is charging, with the presence of significant harmonic content. The transient test is repeated with the APD controller enabled.

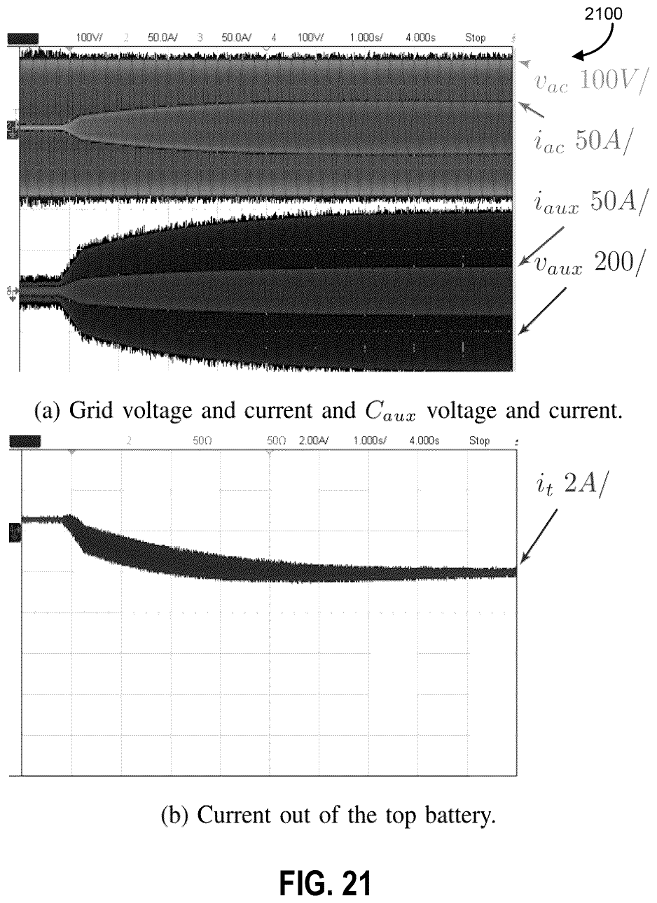

The results are shown in the set of graphs 2100 of FIG. 21. As the step is applied to the reference current, the system increases the grid current, 10 as shown in FIG. 21(a). The APD control system sets the auxiliary capacitor voltage to assure zero second-harmonic current ripple on the battery. Consequently, as the grid current magnitude and power increase, the auxiliary capacitor voltage magnitude increases. Driven by the capacitor voltage, the capacitor current also increases, leading to a higher magnitude of second-harmonic power into the capacitor. The current into the battery does not display any significant second-harmonic, suggesting that the controller has acceptable performance.

This effect is seen in FIG. 21(b) the current displays a negative dc value after the load step, without an increased ripple. Simulations demonstrate both the power transfer functionality and the active power decoupling. A scaled experimental prototype charger is built and used to demonstrate steady state operation, showcasing a 99.7% reduction in battery ripple current and the system's behavior during charging current transient.

In the below section, a dual inverter variation is proposed. This is a variant approach showing a dual inverter integrated three-phase charger (e.g., EV charger) that is based on the split-phase machine approach described in various embodiments of this disclosure.

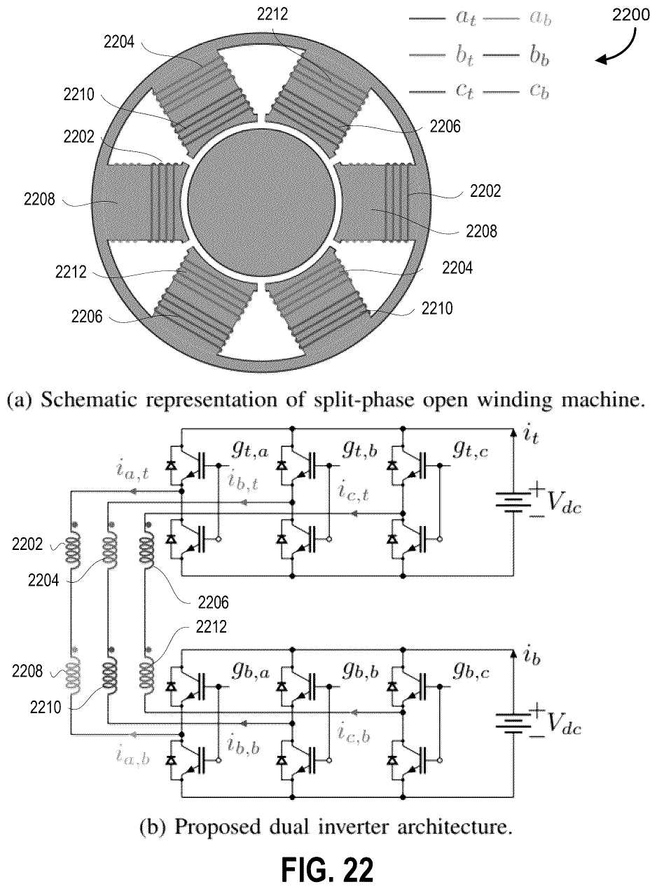

The proposed topology consists of a drivetrain formed by a split-phase open winding machine driven by a dual inverter architecture. FIG. 22 shows a schematic representation 2200 and a proposed dual inverter architecture for a proposed drivetrain with a dual inverter controlling a split-phase, open winding machine, according to some embodiments. A representation of the machine's stator is provided in FIG. 22(a), with windings at 2202, bₜ 2204, cₜ 2206, a_{b} 2208, b_{b} 2210, c_{b} 2212, where, without loss of generality, a two-pole stator and round rotor are depicted. The dual inverter and its connection to the machine, labelled correspondingly, are shown in FIG. 22(b).

A variety of rotor types are suitable for implementing this system, without significant difference in charging functionality, including slip ring, squirrel cage, permanent magnet, and wound synchronous rotor. Therefore, only the rotor magnetic core is represented in FIG. 22(a).

The drivetrain can be operated in driving mode using a classic control strategy appropriate to the rotor type. Since the driving operation is extensively discussed in the literature, the topic is not addressed in this work, other than demonstrating that charging operation does not result in torque production via analysis, simulation, and experimental results.

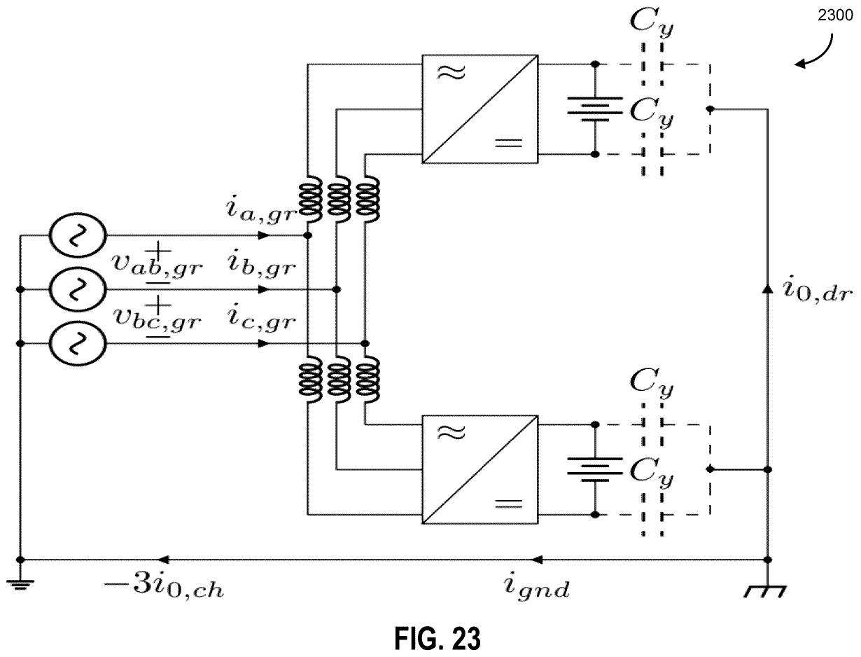

To operate the system in charging mode, a three-phase grid can be connected to the split-phase point of each phase of the machine, as shown in the circuit representation 2300 of FIG. 23. During charging operation, the vehicle's chassis is assumed to be connected to ground via a protective earth conductor to ensure zero potential at the accessible chassis, as required by the standard. The current flowing through the protective earth conductor, i_{gnd}, by standard, is required to be monitored by a residual current monitoring device, which interrupts the charging process if the value exceeds a specified threshold. In that context, the y-capacitances, present between the battery and chassis, become relevant, as these components complete the path through which i_{gnd} may flow.

The y-capacitances can be included, by design, as a discrete component, or arise due to parasitic effects in the system. Given the presence of y-capacitances and protective earth conductor in the system, as shown in FIG. 23, it is necessary to devise and consider the CM model of the system, taking measures to ensure low CM currents during the charging process in order to avoid nuisance tripping of protective systems.

The model and operating principle is proposed herein. A generalized Clarke transformation can be defined to decompose the system into six components. The voltage resulting from the transformation is described as:

$$[ \begin{matrix}{v}_{α , dr} \\ {v}_{β , dr} \\ {v}_{0 , dr} \\ {v}_{α , ch} \\ {v}_{β , ch} \\ {v}_{0 , ch}\end{matrix} ] = {V}_{dc} [ \begin{matrix}C & - C \\ \frac{1}{2} C & \frac{1}{2} C\end{matrix} ] [ \begin{matrix}{g}_{a , t} \\ {g}_{b , t} \\ {g}_{c , t} \\ {g}_{a , b} \\ {g}_{b , b} \\ {g}_{c , b}\end{matrix} ] - [ \begin{matrix}0 \\ 0 \\ 0 \\ 0 \\ 0 \\ \frac{{V}_{dc}}{2}\end{matrix} ]$$

whereas the current is described as:

$$[ \begin{matrix}{i}_{α , dr} \\ {i}_{β , dr} \\ {i}_{0 , dr} \\ {i}_{α , ch} \\ {i}_{β , ch} \\ {i}_{0 , ch}\end{matrix} ] = [ \begin{matrix}\frac{1}{2} C & - \frac{1}{2} C \\ C & C\end{matrix} ] [ \begin{matrix}{i}_{a , t} \\ {i}_{b , t} \\ {i}_{c , t} \\ {i}_{a , b} \\ {i}_{b , b} \\ {i}_{c , b}\end{matrix} ] .$$

In the above, in respect of the voltage, the gating pulses are defined to be 1, when the associated transistor is on and 0 otherwise, C is the 3×3 Clarke transformation matrix, defined as

$$C = \frac{2}{3} [ \begin{matrix}1 & - \frac{1}{2} & - \frac{1}{2} \\ 0 & \frac{\sqrt{3}}{2} & - \frac{\sqrt{3}}{2} \\ \frac{1}{2} & \frac{1}{2} & \frac{1}{2}\end{matrix} ] .$$

The charging voltage space-vector is defined as

\vec{v}_{ch}=v_{a,ch}+jv_{β,ch} and represents the voltage used to control the charging current.

The driving voltage space-vector is defined as

$${\vec{v}}_{dr} = {v}_{α , dr} + {jv}_{β , dr}$$

and represents the voltage used to generate magnetic flux through the rotor and control torque production, the quantity v_{0,dr} represents the zero-sequence voltage applied to the motor terminals by the dual inverter, the quantity v_{0,ch} represents the CM voltage applied in the direction of producing CM leakage current through the ac grid.

\vec{i}_{gr}=−\vec{i}_{ch}=−(i_{a,ch}+j_{iβ,ch}) is the space-vector current

flowing through the three-phase grid connection.

\vec{i}_{dr}=i_{a,dr}+ji_{β,dr} is the driving current, which produces rotating flux through the rotor.

i_{0,dr} is the zero-sequence current flowing through the machine.

i_{gnd}=−3i_{0,ch} is the common mode (CM) leakage current flowing through the grid.

Combined, these two transformations result in the definition of four submodels, respectively associated with each one of the subsystems' effects: driving, charging, zero-sequence, and CM current. As shown by the model, the four subsystems are mathematically and conceptually decoupled from one another.

The system can, then, be understood as 4 subsystems, which combined account for the six degrees of freedom of the total system.

The charging subsystem, comprising \vec{i}_{ch}, \vec{v}_{ch}, and, when present, \vec{v}_{gr}, describes the current exchange via the split phase connection of the machine and accounts for two degrees of freedom,

The driving subsystem, comprising \vec{i}_{dr}, \vec{v}_{dr}, and, when moving, \vec{v}_{bemf}, describes the two degrees of freedom responsible for torque production.

The zero-sequence subsystem, comprising i_{0,dr} v_{0,dr} and describes the generation of zero-sequence current through the machine stator windings.

The CM subsystem, comprising i_{0,ch} and v_{0,ch}, describes the generation of CM current through the grid.

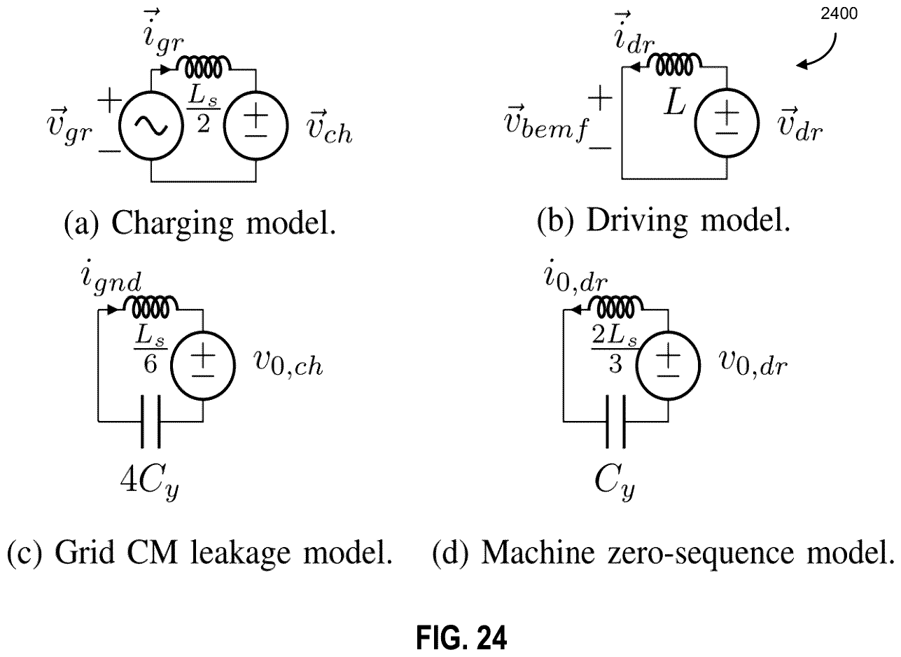

Note that these subsystems describe the degrees of freedom associated with each operation. As a modelled description, the subsystems exist even when they are idle. For instance, the charging system exists even when the vehicle is not charging. For illustration purposes, the four subsystems are shown in this section. FIG. 24 shows a set of circuit model diagrams 2400 showing decoupled representation of the 4 subsystems resulting from the proposed topology during charging operation. Lₛ represents the machine's per-phase leakage inductance and L represents the positive sequence inductance. \vec{v}_{bemf} is the back electromotive force produced by the machine, shown in the driving model in FIG. 24(b). C_{y} is the y-capacitance coupling each battery to the vehicle's chassis, according to some embodiments. A non-salient PMSM is chosen for this representation, since the machine model is the simplest. However, the proposed approach is valid for different rotor types. In fact, to demonstrate this flexibility, the experiments are conducted on an IM. During charging operation, the three-phase grid is connected to the system, providing the voltage space-vector, from which the system charges by transferring power via the model represented in FIG. 24(a). In this condition, the grid connection and the protective earth connection provide a path for CM leakage current through the y-capacitances, as represented in FIG. 24(c).

During charging operation, for safety reasons, the machine must remain stationary. This is achieved by applying [symbol] \vec{v}_{dr} [symbol] =0

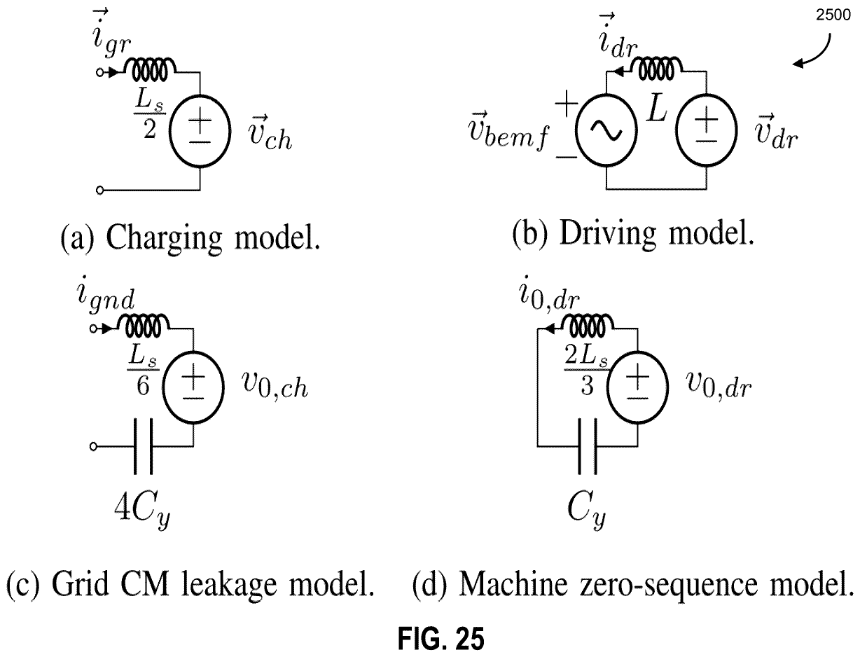

FIG. 25 is a set of circuit model diagrams 2500 showing a set of decoupled representations of the 4 subsystems resulting from the proposed topology during driving operation, according to some embodiments. For induction machines, this approach ensures the stator is not excited, therefore not producing any torque. For PMSMs, zero driving voltage implements an active short and acts like an virtual strong brake, thereby locking the rotor in place. The system is assumed to be disconnected from the grid and protective earth conductor during driving operation. As a result, the subsystems represented in FIG. 25(a) and FIG. 25(c) feature an open circuit, signifying the lack of a current carrying path. The model relevant for driving operation is represented in FIG. 25(b) and includes a nonzero \vec{v}_{bemf}, produced by the machine as a result of nonzero speed. No significant changes are observed in the zero-sequence model.

A control system for driving operation can be devised using the submodel depicted in FIG. 25(b). The submodels represented in FIG. 25(a) and FIG. 25(c) do not need be considered in the control design, as current flow through the associated degrees of freedom is not possible. The model represented FIG. 25(d) may, in some circumstances, be neglected, as the typically small values of Cy result in a high impedance which renders the magnitude of i_{0,dr} insignificant for the system.

During charging operation, the system must control the charging voltage \vec{v}_{ch} In order to avoid torque production, it is desired that the average driving voltage \vec{v}_{dr} over a switching cycle is 0. Lastly, the system is designed not to require galvanic isolation. Therefore, the instantaneous voltage v_{0,ch} must be 0 at all times, in order to mitigate CM current production and meet the strict CM standard requirements. It is important to note that, in contrast with the model represented in FIGS. 24(d) and 25(d), the model in FIG. 24(c) must be carefully considered, as even CM leakage currents in the mA range may cause nuisance tripping.

A modulator is proposed to ensure the conditions stated in this paragraph are met, allowing the system to charge while not producing torque, zero-sequence current through the machine, or CM currents through the grid.

By virtue of the decoupled nature of the four subsystems, it is possible to devise a control architecture that tracks a desired charging current by applying a suitable value of v_{ch} to the system, while not generating any current through the other subsystems. In this section, the control architecture which determines the reference voltage

$${\vec{v}}_{ch}^{*}$$

is briefly discussed.

A proposed modulator approach is then introduced, which, in light of the four subsystems introduced above, synthesizes

$$〈 {\vec{v}}_{ch} 〉 = {\vec{v}}_{ch}^{*} ,$$

outputting the reference voltage produced by the control system, while ensuring, [symbol] \vec{v}_{dr} [symbol] =0, thereby preventing torque production, [symbol] v_{0,dr} [symbol] =0, and, most importantly, v_{0,ch}(t)=0 ∀t, eliminating CM voltage generated by the system.

In the above equations, [symbol] x [symbol] represents the average, over a switching cycle, of the quantity x, whereas v_{0,ch}(t)=0 ∀t, refers to the instantaneous value of v_{0,ch}.

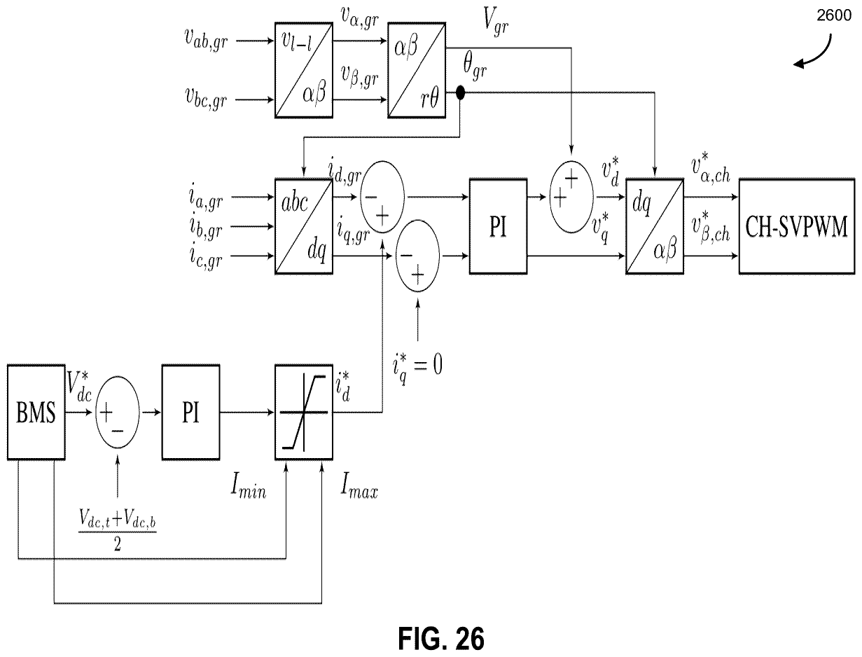

FIG. 26 is a circuit diagram 2600 showing an example control architecture that can be used during charging operation of the proposed integrated drivetrain charger, according to some embodiments. The control system architecture used in the simulations and experiments performed in this paper is shown in FIG. 26 and implements a version of the conventional constant voltage-constant current (CC-CV) charging approach. In the control system depicted in FIG. 26, the line-to-line voltages at the grid connection are measured, and a Clarke transformation is used to express the voltages in the stationary reference frame (SRF). The result is fed into a rectangular-to-polar transformation to determine the magnitude of the grid voltage, v_{gr}, and the associated angle, θ_{gr}. The line currents are measured and transformed into a rotating reference frame (RRF) aligned with θ_{gr}.

The CV controller determines the required current coming from the grid in order to bring the average battery voltage to the reference value

$${V}_{dc}^{*} ,$$

defined by a battery management system (BMS). The result is saturated to a maximum current to produce the current reference

$${i}_{d}^{*} ,$$

which the CC controller enforces. The BMS defines the saturation limits considering the battery and grid current capabilities. Unity power factor is enforced by defining

$${i}_{q}^{*} = 0.$$

The output of the current controller is added to a feed-forward voltage based on the grid voltage, and the result is rotated back to the SRF. Finally, this voltage is sent to the proposed charging space-vector modulator (CH-SVPWM), described in various other embodiments.

A. Available Switching States In order to ensure minimal leakage current,

$$\frac{d}{dt} {v}_{0 , ch} = 0$$

must be respected at all times. Applying v_{0,ch}=0, achieves this objective while allowing for maximum available number of switching states.

It is therefore convenient to list all of the possible switching states at which v_{0,ch}=0. Table II lists all such states, and accounts for 20 of the total 64 possible switching states.

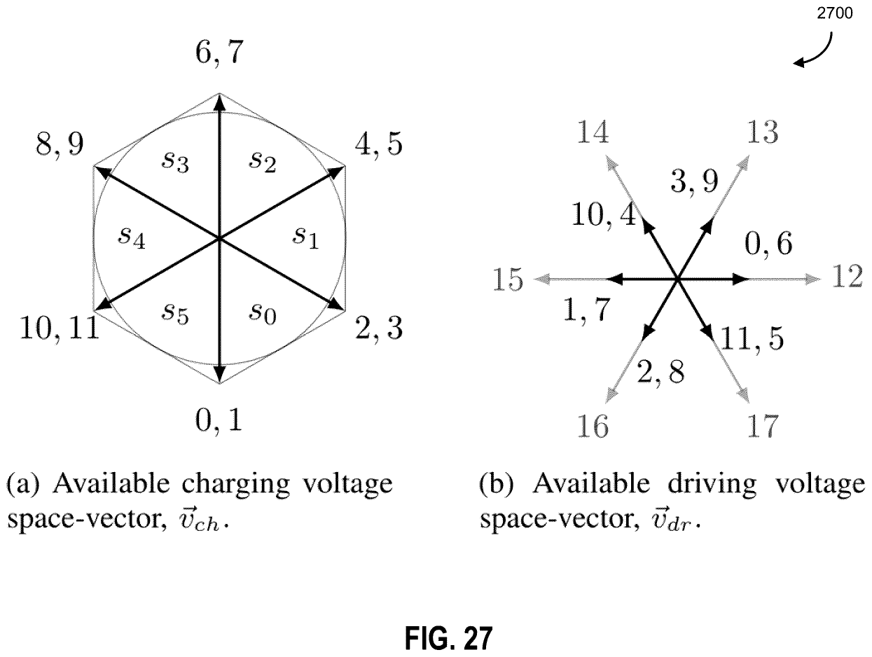

In the table, \vec{v}_{dr}, v_{0,dr} and \vec{v}_{ch} are also shown. The space-vector diagrams 2700 resulting from Table II are shown in FIG. 27. FIG. 27(a), on the left, shows the attainable nonzero charging voltage space-vectors, whereas FIG. 27(b), on the right, shows the nonzero driving voltages space-vectors, as defined in the earlier sections.

### Proposed Modulation

The modulator is devised constraining the system to the switching states presented in Table II, inherently ensuring v_{0,ch}(t)=0 ∀t and, as a result, minimal CM leakage current generated by the charger.

TABLE II
Switching states producing 0 CM voltage.

| State | g_{a,t}g_{b,t}g_{c,t}g_{a,b}g_{b,b}g_{c,b} | \vec{υ}_{dr} | υ_{0,dr} | \vec{υ}_{ch} | υ_{0,ch} |
|---|---|---|---|---|---|
| 0 1 | 1 0 1 0 0 1 0 0 1 1 0 1 | $\frac{2 {V}_{dc}}{3} ∠0°$ $\frac{2 {V}_{dc}}{3} ∠180°$ | $\begin{matrix}\frac{{V}_{dc}}{3} - \\ \frac{{V}_{dc}}{3}\end{matrix}$ | $\frac{{V}_{dc}}{3} ∠ - 90 °$ $\frac{{V}_{dc}}{3} ∠ - 90 °$ | 0 0 |
| 2 3 | 1 0 1 1 0 0 1 0 0 1 0 1 | $\frac{2 {V}_{dc}}{3} ∠ - 120 °$ $\frac{2 {V}_{dc}}{3} ∠60°$ | $\begin{matrix}\frac{{V}_{dc}}{3} - \\ \frac{{V}_{dc}}{3}\end{matrix}$ | $\frac{{V}_{dc}}{3} ∠ - 30 °$ $\frac{{V}_{dc}}{3} ∠ - 30 °$ | 0 0 |
| 4 5 | 1 1 0 1 0 0 1 0 0 1 1 0 | $\frac{2 {V}_{dc}}{3} ∠120°$ $\frac{2 {V}_{dc}}{3} ∠ - 60 °$ | $\begin{matrix}\frac{{V}_{dc}}{3} - \\ \frac{{V}_{dc}}{3}\end{matrix}$ | $\frac{{V}_{dc}}{3} ∠ 30 °$ $\frac{{V}_{dc}}{3} ∠ 30 °$ | 0 0 |
| 6 7 | 1 1 0 0 1 0 0 1 0 1 1 0 | $\frac{2 {V}_{dc}}{3} ∠0°$ $\frac{2 {V}_{dc}}{3} ∠180°$ | $\begin{matrix}\frac{{V}_{dc}}{3} - \\ \frac{{V}_{dc}}{3}\end{matrix}$ | $\frac{{V}_{dc}}{3} ∠ 90 °$ $\frac{{V}_{dc}}{3} ∠ 90 °$ | 0 0 |
| 8 9 | 0 1 1 0 1 0 0 1 0 0 1 1 | $\frac{2 {V}_{dc}}{3} ∠ - 120 °$ $\frac{2 {V}_{dc}}{3} ∠60°$ | $\begin{matrix}\frac{{V}_{dc}}{3} - \\ \frac{{V}_{dc}}{3}\end{matrix}$ | $\frac{{V}_{dc}}{3} ∠ 150 °$ $\frac{{V}_{dc}}{3} ∠ 150 °$ | 0 0 |
| 10 11 | 0 1 1 0 0 1 0 0 1 0 1 1 | $\frac{2 {V}_{dc}}{3} ∠120°$ $\frac{2 {V}_{dc}}{3} ∠ - 60 °$ | $\begin{matrix}\frac{{V}_{dc}}{3} - \\ \frac{{V}_{dc}}{3}\end{matrix}$ | $\frac{{V}_{dc}}{3} ∠ - 150 °$ $\frac{{V}_{dc}}{3} ∠ - 150 °$ | 0 0 |
| 12 13 14 15 16 17 | 1 0 0 0 1 1 1 1 0 0 0 1 0 1 0 1 0 1 0 1 1 1 0 0 0 0 1 1 1 0 1 0 1 0 1 0 | $\frac{4 {V}_{dc}}{3} ∠0°$ $\frac{4 {V}_{dc}}{3} ∠60°$ $\frac{4 {V}_{dc}}{3} ∠120°$ $\frac{4 {V}_{dc}}{3} ∠180°$ $\frac{4 {V}_{dc}}{3} ∠ - 120 °$ $\frac{4 {V}_{dc}}{3} ∠60°$ | $\begin{matrix}\frac{{V}_{dc}}{3} - \\ \frac{{V}_{dc}}{3}\end{matrix}$ $\begin{matrix}\frac{{V}_{dc}}{3} - \\ \frac{{V}_{dc}}{3}\end{matrix}$ $\begin{matrix}\frac{{V}_{dc}}{3} - \\ \frac{{V}_{dc}}{3}\end{matrix}$ | 0 0 0 0 0 0 | 0 0 0 0 0 0 |
| 18 | 1 1 1 0 0 0 | 0 | V_{batt} − | 0 | 0 |
| 19 | 0 0 0 1 1 1 | 0 | V_{batt} | 0 | 0 |

The table above is useful to recognize that while there are 64 potential switching states, there are 20 that are useful in respect of the proposed approach.

In particular, the approach can be used to control operation such that the state control of the system is based at least on the 20 switching states.

While it is preferred to have the system constrained to the 20 switching states, it is important to note that the control does not necessarily need to be limited to just the 20 states. The contribution of states outside of the 20 switching states to undesirable common mode/torque can depend on the amount of time in a state, and the state itself. For example, a state outside of the table can be used for a short time, as there may be some minimal level of common mode operation or torque that is acceptable before a particular threshold (e.g., threshold for nuisance tripping of the circuit). Accordingly, the state control can be established to be based at least on the 20 switching states such that the overall common mode operation or torque is below the nuisance tripping threshold.

In a second variation, the system is constrained for operation in 20 of the states.

In a third variation, a sequence of states is established based at least on the 20 switching states above.

In a fourth variation, the sequence of states is constrained to the 20 states above.

The sequence of states is defined to be followed can be dependent on the sector at which the voltage that the modulator is required to synthesize is—by sector, what is meant is the range of angles at which the voltage that the modulator needs to synthesize.

By way of example, there is defined an example sequence that would be followed in the sector 0 in the paragraph following, and then it can be extrapolated to other sectors.

A further description of the modulator, which can be used for implementation, is provided in the Appendix. The Appendix shows an example approach for extrapolation.

The discussion presented in this section assumes, a reference voltage in sector s0 (as defined in FIG. 27(a)), for simplicity.

Under this simplifying assumption, the sequence of switching states used by the system, over one switching period, is 18→0→3→19→1→2→18.

Other orders are possible, such as conducted the sequence in the reverse order.

The synthesized charging voltage, averaged over a switching period, is given by

$$〈 [ \begin{matrix}{v}_{α , ch} \\ {v}_{β , ch}\end{matrix} ] 〉 = \frac{{V}_{dc} {f}_{sw}}{\sqrt{3}} [ \begin{matrix}0 & \frac{\sqrt{3}}{2} \\ - 1 & - \frac{1}{2}\end{matrix} ] [ \begin{matrix}{t}_{0} + {t}_{1} \\ {t}_{2} + {t}_{3}\end{matrix} ]$$

where tx is the time spent at switching state x.

This method can ensure the condition stated above by determining the dwell times as

$$[ \begin{matrix}{t}_{0} \\ {t}_{2}\end{matrix} ] = [ \begin{matrix}{t}_{1} \\ {t}_{3}\end{matrix} ] = {\frac{\sqrt{3}}{2 {V}_{dc} {f}_{sw}} [ \begin{matrix}0 & \frac{\sqrt{3}}{2} \\ - 1 & - \frac{1}{2}\end{matrix} ]}^{- 1} [ \begin{matrix}{v}_{α , ch}^{*} \\ {v}_{β , ch}^{*}\end{matrix} ]$$

Another implication of the above is that is that v_{0,ch}(t)=0 ∀t is also met.

This is a result of the three factors that (1) switching states 0 and 1 produce diametrically opposed instantaneous driving voltage, (2) t₀=t₁, canceling the contribution of each switching state, (3) the same happens for switching states 2 and 3.

Lastly, this approach can also meet the condition v_{0,ch}(t)=0 ∀t, by setting t₁₈=t₁₉, equaling dividing the remaining of the switching period between these two states. The zero-sequence voltage is canceled because each one of the following pairs of switching states cancels the contribution towards [symbol] v₀,dᵣ [symbol] ; states 0 and 1, states 2 and 3, and states 18 and 19. Note that this approach does not uses the switching states 12-17 since these states' zero charging vector can be achieved by simply using states 18 and 19.

Simulations are described in this section.

The system shown in FIG. 22 is simulated using the parameters listed in Table III.

TABLE III
Parameters used in simulations and experiments.

| Parameter | Description | Value | |
|---|---|---|---|
| Battery Voltages | V_{dc} | 400 | V |
| Switching Frequency | f_{sw} | 10 | kH |
| Grid Voltage | V_{gr} | 208 | Vᵣₘₛ |

Rated Machine Data

| | | | |
|---|---|---|---|
| Leakage Inductance | Lₛ | 6 | mH |
| Line Voltage | Vₘ | 230 | Vᵣₘₛ |
| Line Current | Iₘ | 10 | Aᵣₘₛ |
| Phase Resistance | Rₛ | 0.5 | Ω |
| Nominal Power | Pₘ | 15 | hp |
| Nominal Torque | T_{qm} | 30 | Nm |

Lₛ refers to the leakage inductance of the machine across each HW. Similarly, Rₛ refers to the resistance through one HW. Note that the impedance seen by the charging operation is half of that of a HW, given the parallel connection. Similarly, the maximum charging current is twice the rated phase current. The parameters used in the simulation are based on those used for experimental verification, presented later.

The experimental setup, in turn, is a scaled-down model of the proposed system, given the limitations imposed by the available induction machine. To operate with a 400 Vᵣₘₛ line voltage grid, for instance, while maintaining the \vec{v}_{ch} inside of the feasible region, described in FIG. 27(a), the minimum dc-link battery, at the lowest state of charge, should be

$${V}_{dc} \leq 400 \frac{2 \sqrt{2}}{\sqrt{3}} + σ \approx 653 V + σ$$

where σ is an appropriate safety margin.

At time t=0 the reference charging current is stepped up from 0 A to 20 A. The converter starts switching at the same time.

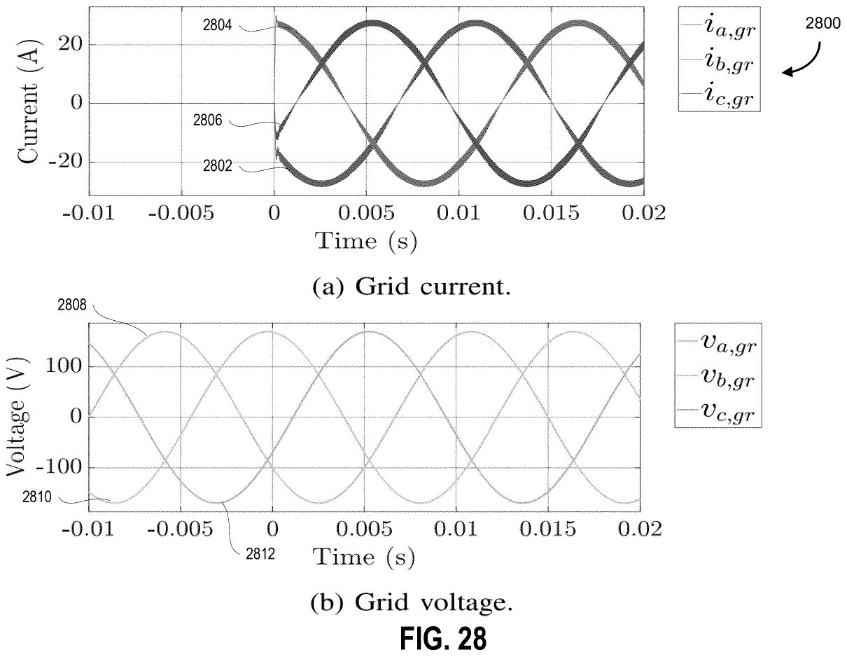

FIG. 28 is a set of graph trace diagrams 2800 showing grid phase quantities under transient step in charging current reference, according to some embodiments. FIG. 28(a) shows grid current (i_{a,gr} 2802, i_{b,gr} 2804 i_{c,gr} 2806) and FIG. 28(b) shows grid voltage (v_{a,gr} 2808, v_{b,gr} 2810 v_{c,gr} 2812). Grid line currents and phase voltages are shown in FIG. 28. The currents are sinusoidal and in phase with the grid voltage. The system is assumed to be operating in CC mode.

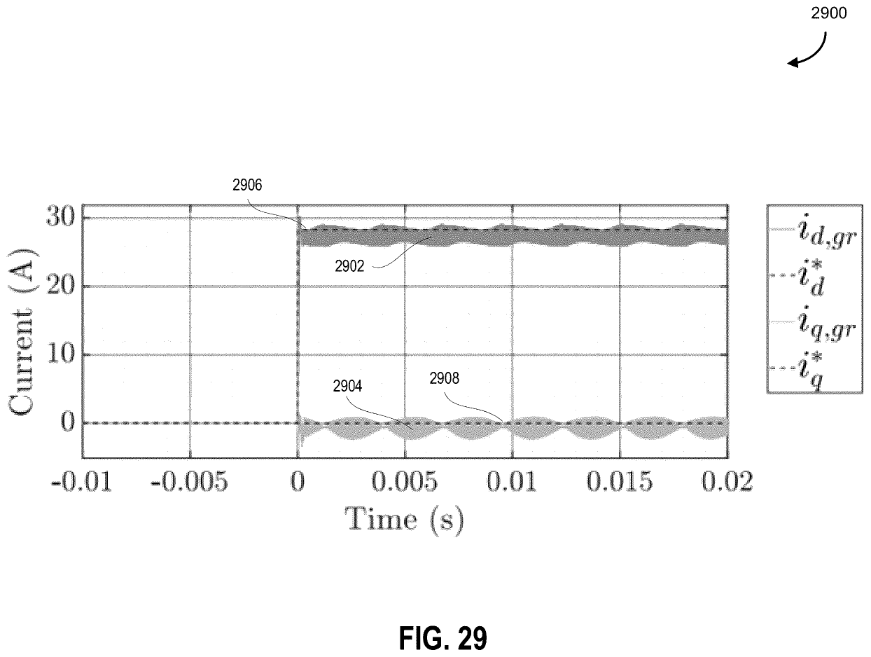

Therefore, the current reference is immediately stepped up. FIG. 29 is a graph diagram 2900 showing direct-axis representation of the grid current (i_{d,gr} 2902 and i_{q,gr} 2904) and its reference value from simulation, according to some embodiments. The control response is shown in FIG. 29, where the currents have been transformed to the RRF for ease of interpretation. The d-axis current reference 2906 is the one to increase, as this axis is connected to active power exchange with the grid. On the other hand, the q-axis reference 2908 is kept at 0, as this axis is related with reactive power and unity power factor is desired. The CM voltage produced by the inverter is measured.

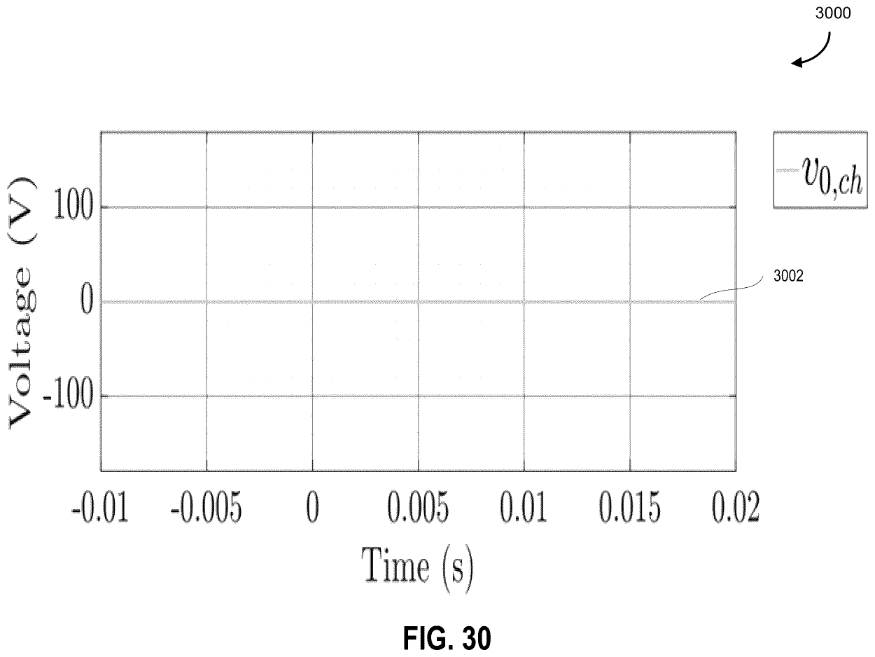

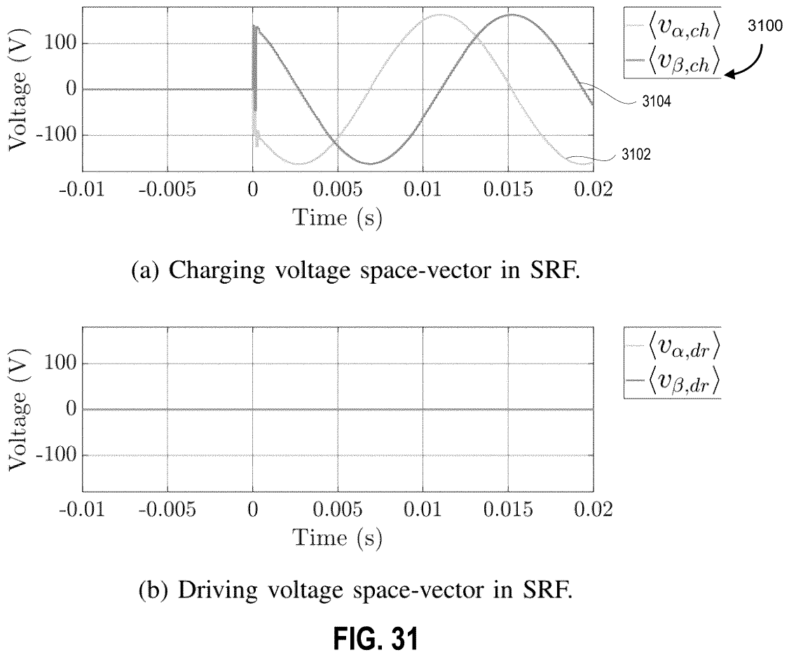

The results are shown in graph 3000 of FIG. 30. FIG. 30 shows a common mode voltage space-vector 3002 generated by the dual inverter during charging operation, according to some embodiments. It can be observed that the proposed modulator ensures zero instantaneous CM voltage at all times in simulation. The voltage produced by the inverter in simulation is averaged over a switching period and transformed according to (1), from which the space-vector charging and driving voltages are shown in FIG. 31.

FIG. 31 is a set of graph trace diagrams 3100 showing voltage space-vectors decomposed, averaged over a switching cycle, according to some embodiments. FIG. 31(a) shows the charging voltage space-vector in SRF. FIG. 31(b) shows the driving voltage space-vector in SRF. The charging voltage space-vector is shown in FIG. 31(a) and both the a 3102 and β 3104 components are sinusoidal. The averaged driving voltage is shown in FIG. 31(b), confirming it is zero, as desired, by how the modulation is implemented. Combined, these two results highlight how the modulator can produce controllable charging voltage while producing zero flux-generating voltage.

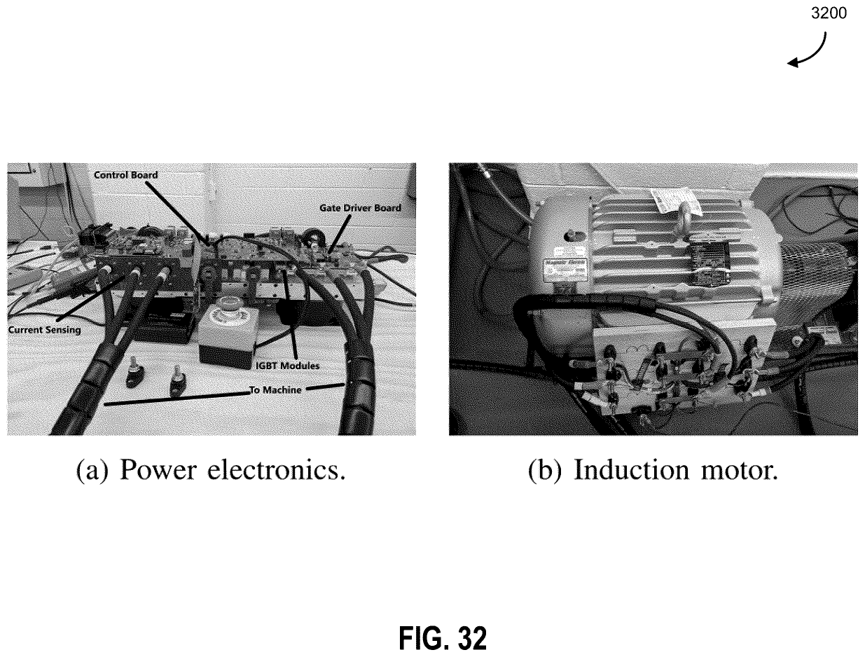

Experimental verification is described below. As noted, the system discussed above is implemented for experimental verification. In this analysis, the parameters are identical to those used in simulation. The experimental setup 3200 is shown in FIG. 32. The motor used in this setup is a three-phase Baldor EM2394T, modified to have open winding and each phase split into two HW, as shown in FIG. 22. The machine has the same resistance as stated in Table III.

A digital torque transducer, model DR-2412-P, from LORENZ MESSTECHNIK GmbH™, is included to demonstrate zero torque production. A specialized Rogolski coil is used to measure the CM current flowing from the grid. The experiments presented in this section are 1) grid-to-vehicle operation with a conventional sinusoidal PWM modulation, providing a benchmark for the production of CM currents, 2) grid-to-vehicle operation, showcasing zero torque production and near zero CM currents, 3) vehicle-to-grid operation, showcasing zero torque production and near zero CM currents, and 4) constant current-constant voltage charging operation, demonstrating operation in a realistic charging regiment.

In the first experiment, the circuit shown in FIG. 22 is used to charge from the three-phase grid, at 20 Aᵣₘₛ and unity power factor.

In this test, a PWM modulation, can be used to serve as a baseline for CM production. This test uses the control architecture shown in FIG. 26.

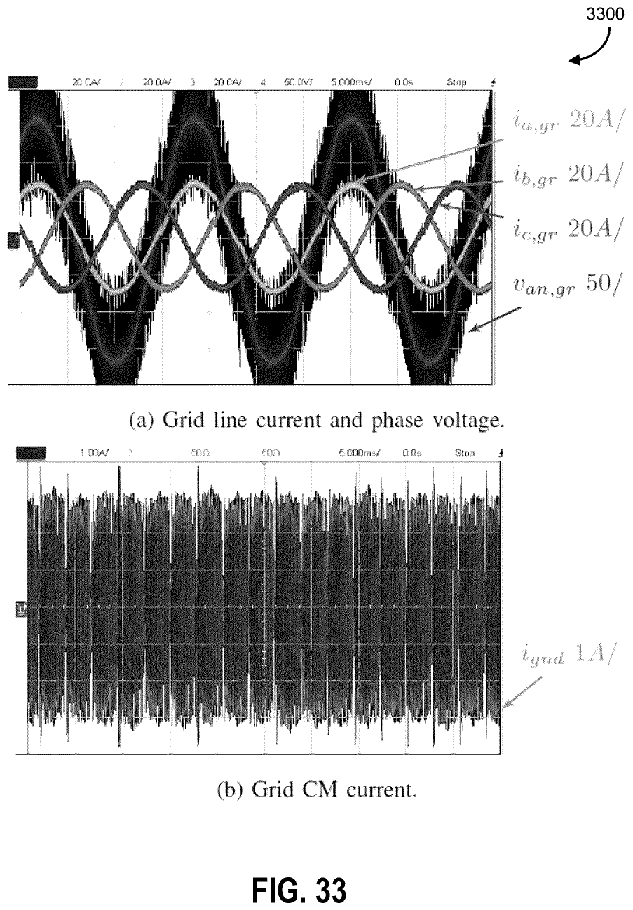

FIG. 33 is a set of graph trace diagrams 3300 showing experimental results during G2V operation using a conventional PWM. The grid line currents and phase voltage are shown in FIG. 33(a). The CM current, shown in FIG. 33(b), is measure to be 2.0 Arms and, as demonstrated later in this paper, well above the limits prescribed by standard regulation. Moreover, the high sensitivity current sensor used to measure the CM current has a maximum instantaneous readable current amplitude of 2.5 A, and a clear clipping effect is observed, in FIG. 33(b), around 3 A, suggesting the actual RMS CM current is well above the measured value.

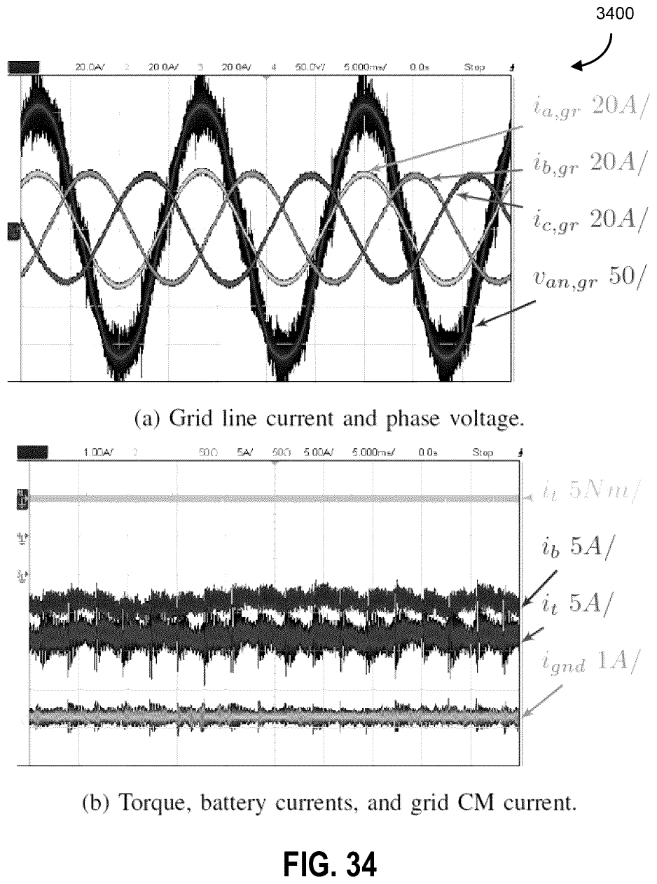

G2V operation is conducted once more at 20 Aᵣₘₛ and unity power factor. This time, the system used the proposed modulation. The results are shown in FIG. 34. FIG. 34 is a set of graph trace diagrams 3400 showing experimental results during G2V operation using the proposed modulation, according to some embodiments. FIG. 34(a) shows the measured grid line currents and phase voltage.

While the currents are approximately the same, the voltage seems to have less noise. This suggests the noise results from the CM current generated by the conventional modulation scheme.

The grid CM current is shown in FIG. 34(b), and measured to be 65.4 mAᵣₘₛ, which represents approximately a 30 fold reduction, despite the underestimation of the CM current in the benchmark case due to sensor saturation. The torque is also measured and shown in FIG. 34(b) to be approximately zero. The batteries are charged, as evidenced by the negative currents, shown in FIG. 34(b).

This result suggests that the modulation meets its CM, torque, and charging objectives.

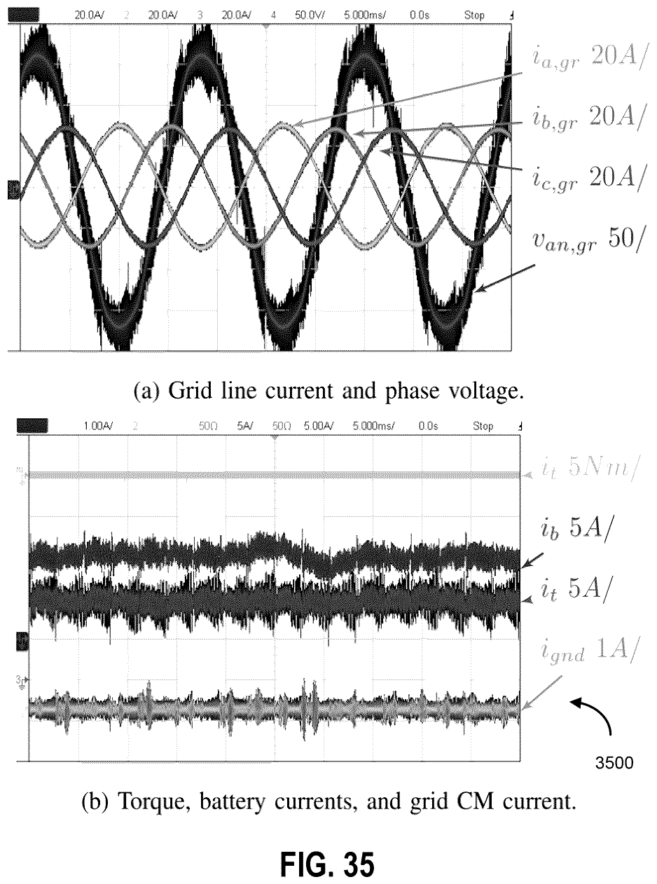

The test is repeated, this time with V2G operation, at 20 Aᵣₘₛ and unity power factor. FIG. 35 is a set of graph trace diagrams 3500 showing experimental results during V2G operation, according to some embodiments. FIG. 35(a) shows the measured grid line currents and phase voltage. The measured torque, grid CM current, and the battery currents are shown in FIG. 35(b).

Once again, no significant torque or CM currents are observed. The only difference to the past test is that the battery currents are positive in the V2G operation, while the grid currents are out of phase with the grid voltage.

The ground-fault current interrupters prescribed by standards do not operate on the exact CM current. Instead, a human body model filter is applied. The protection trips and the charging stops if the output exceeds 20 MIU.

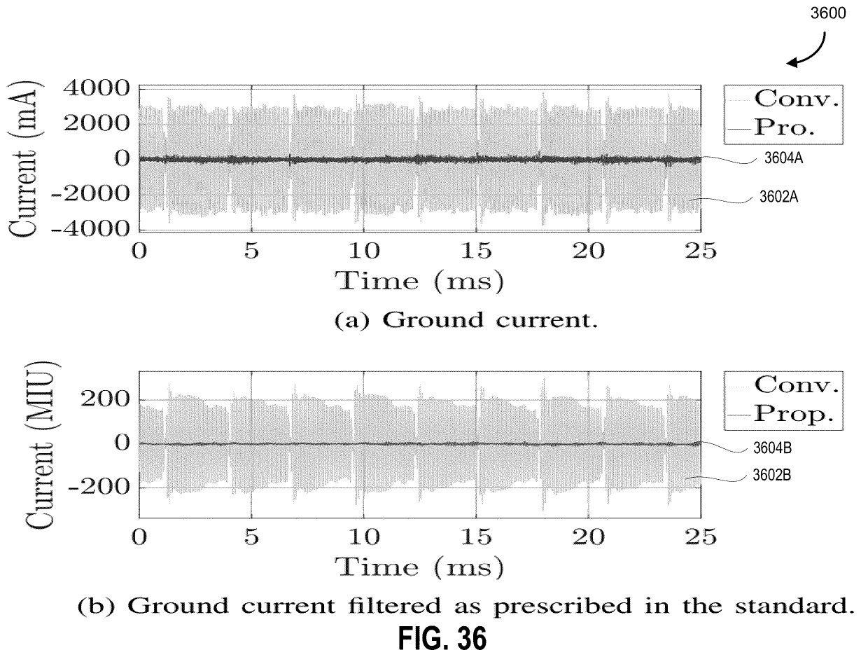

To indicate whether or not the system would trip in the presence of a ground fault current interrupter, the data of the past experiments are exported and filtered using the human body model filter. The results, along with the original data, are shown in FIG. 36. FIG. 36 is a set of graph trace diagrams 3600 showing experimentally measured CM leakage current reduction by the proposed modulation technique, according to some embodiments, with conventional traces 3602A and 3602B and proposed trace 3604A and 3604B. The unfiltered results are shown in FIG. 36(a). The MIU output of the filter is shown in FIG. 36(b), wherein the comparison modulation has a peak of 308 MIU, while the proposed modulation peaks at 12.6 MIU. The results are summarized on Table IV.

TABLE IV
Summary of experimental CM measurements.

| Modulation | CM | CM-MIU | Compliant |
|---|---|---|---|
| Conventional | 2.0 Aᵣₘₛ | 308 MIU | X |
| Proposed | 65.4 mAᵣₘₛ | 12.6 MIU | ✓ |

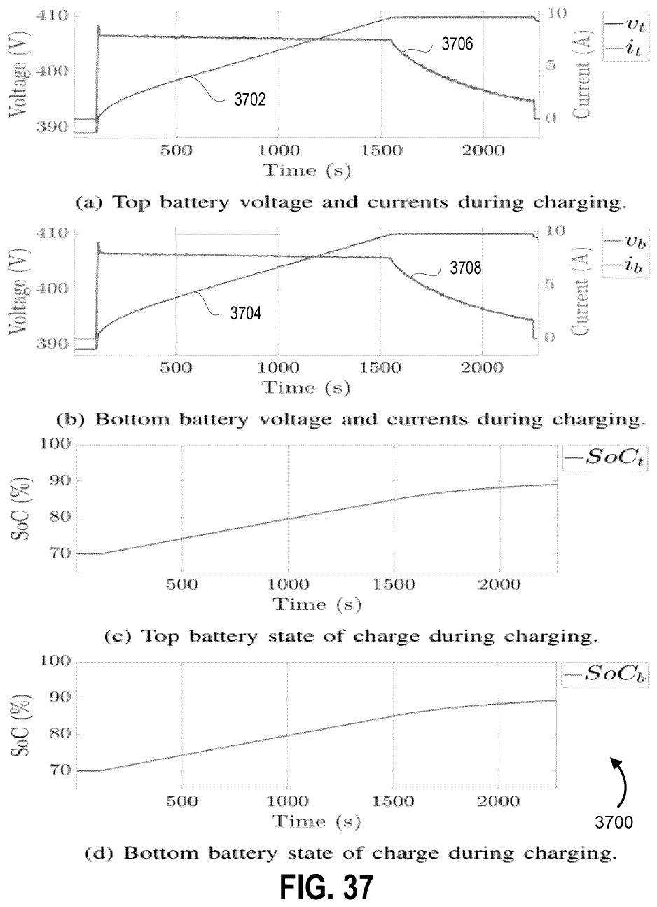

The system is operated through a CC-CV cycle to demonstrate the controller performance in a practical setting. Two EA-PSB 10750-120 power supplies units are used. The power supply software is used to emulate the batteries for the experiments. The battery chosen to be emulated for this test is composed of 100 series-connected lithium-ion cells, with 400 V nominal voltage and 20 Ah capacity, characterizing 8 kWh per battery, and 16 kWh total storage. This capacity is chosen to limit the time required for the experiment to around 30 minutes. In this experiment, the CV controller sets the battery voltage at 410, whereas the CC controller sets the limit of the grid current to 20 Aᵣₘₛ, since the machine used in this test has a constant current specification of 20 Aᵣₘₛ. As a result, this experiment is conducted at 7.2 KW during the CC operation, gradually decreasing during the CV operation. The results are shown in FIG. 37.

FIG. 37 is a set of graph trace diagrams 3700 showing experimental results of CC-CV charging operation with battery emulation power supply EA-PSB, showing data exported by the battery emulator power supply software, according to some embodiments. FIG. 37(a) and FIG. 37(b) show the voltages (vₜ 3702 and v_{b} 3704) and currents (iₜ 3706 and i_{b} 3708on the top and bottom batteries respectively. At the beginning of the test, the system current is set to the maximum, causing the battery voltage to rise. After about 15 minutes of charging, the battery voltage reaches the 410 V set point. At that time, the current setting starts to drop until it reaches 5 Arms at the grid, when the system turns off. At that time, the currents are around 2 A through each of the batteries.

The state of charge (SoC) reported by the power supply is shown in FIG. 37(c) and FIG. 37(d), detailing the rise from the initial 70% SoC to 89% and the end of the test. VI. CONCLUSION This work presents a topology that can perform non isolated three-phase charging for electric vehicles using a drivetrain based on the dual inverter architecture. The model of the system is derived, wherein the circuit is decomposed into four conceptually and mathematically decoupled subsystems, related to (i) charging, (ii) driving, (iii) CM current, and (iv) zero-sequence current generation.

By employing a separate dc link to each inverter, the system prevents circulation of zero sequence current during driving operation, as demonstrated by the zero-sequence subsystem. A bespoke SVPWM is proposed using this model, which can be used with the topology introduced here. The introduced modulation ensures vastly superior CM current flowing through the ac grid, compared to a conventional modulation benchmark, in the absence of galvanic isolation, allowing for standard-compliant non isolated deployment.

Simulations and experimental verification are presented to validate the model, including CC-CV charging of battery emulator power supplies. With the proposed modulation, charging operation is demonstrated to produce zero torque and to reduce the CM currents 30 fold, leading to standard-compliant non isolated operation.

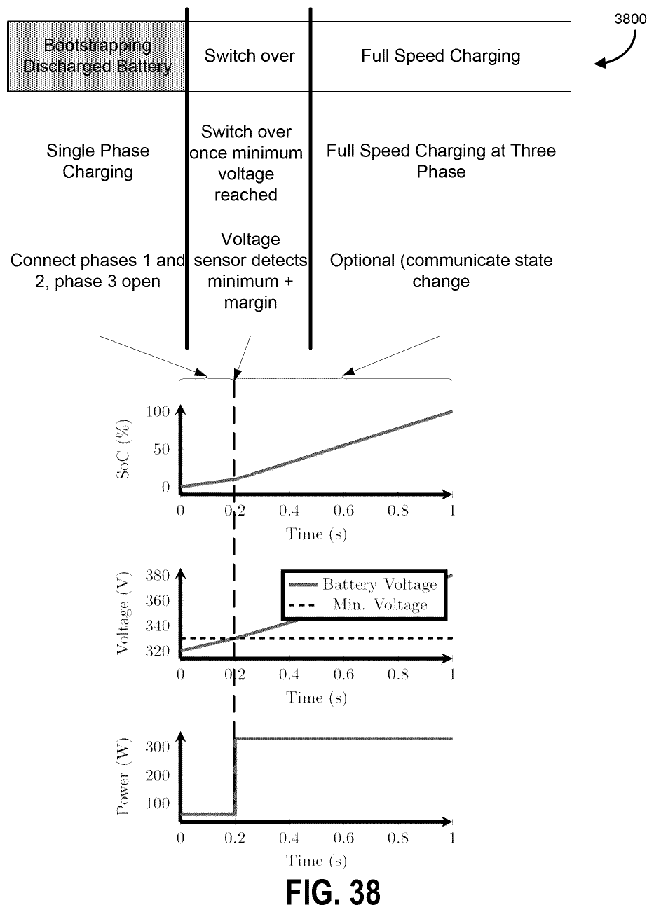

FIG. 38 is an example operational mode diagram 3800 for a bootstrapping variation, according to some embodiments.

In operational mode diagram 3800, a set of operational modes are shown for supporting a charging situation where an energy storage device may be heavily discharged (e.g., empty), and charging is difficult. For example, one can be trying to use 800V batteries to charge from 400V AC, but when the battery is very discharged, it wouldn't charge very well, it would charge in a non-ideal and uncontrolled manner. For example, the minimum needed DC link voltage of the inverters is too low to control the rate and quality of charging current by partially operating as a rectifier, which may cause unwanted heating or damage to the batteries. In this situation, charging is difficult in view of a minimum needed DC link voltage, and different operational characteristics of the approaches described herein can be combined together advantageously.

In particular, the approach starts by using the single phase charging approach to “bootstrap” the battery voltage to a point where the controller then switches over to three phase charging. As charging is ongoing, the voltage on the battery increases. As soon as the voltage on the battery reaches the minimum amount to safely operate as a three phase charger plus a margin, the controller can initiate a switch over (e.g., after a few minutes or a few tens of minutes). This can be conducted using sequencing logic on the controller.

In operation, the controller can control the operation of breaker circuits to control how the phases are coupled. In the beginning of charging, because voltage too low, the controller connects two phases, such as the first two phases, for example, and the breaker on the third is open. There is charging in a single phase mode of operation when two breakers are closed. When the two phases are connected, this is a single phase, just because there is one difference (for example, difference between A and B).

The controller can then switch to three phase by flipping the last breaker and changing controller operation. The controller can thus change between single phase and multi phase charging modes. In some embodiments, the controller is configured to communicate (e.g., by way of a data message) to the charger that it is switching over. In other embodiments, the communication may not be required.

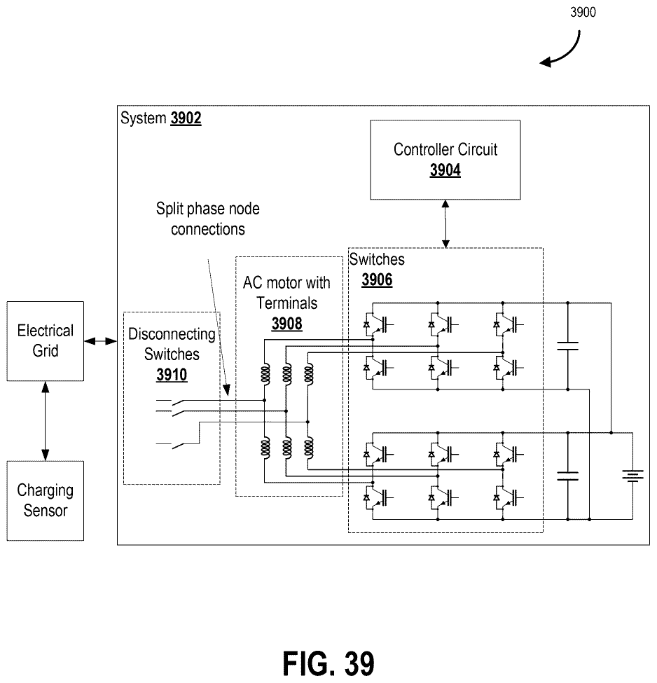

FIG. 39 is an example block diagram 3900 showing example components of the system, according to some embodiments.

In the block diagram 3900, a system 3902 is shown, having a controller circuit 3904 (e.g., a controller unit) that is configured to control the operation of (e.g., through modulation) of switches 3906. The switches 3906 can include different types of electrical switches, such as transistor switches, etc. The switches 3906 are each connected to a terminal of the energy storage means to a respective terminal of an alternating-current (AC) motor 3908, wherein the AC motor 3908 comprises at least six terminals connected to some of the plurality of switches and three split-phase nodes. In another variation, the AC motor 3908 may be replaced with inductive elements. A set of, optional, disconnecting switches 3910, which may be, but are not limited to breakers or disconnectors, are also indicated to facilitate the connection and disconnection if certain phases for single-phase or multi-phase charging as described in the operation of 3900. In this embodiment, the semiconductor devices in the inverter can be different than the disconnecting switches used to connect to the AC network.

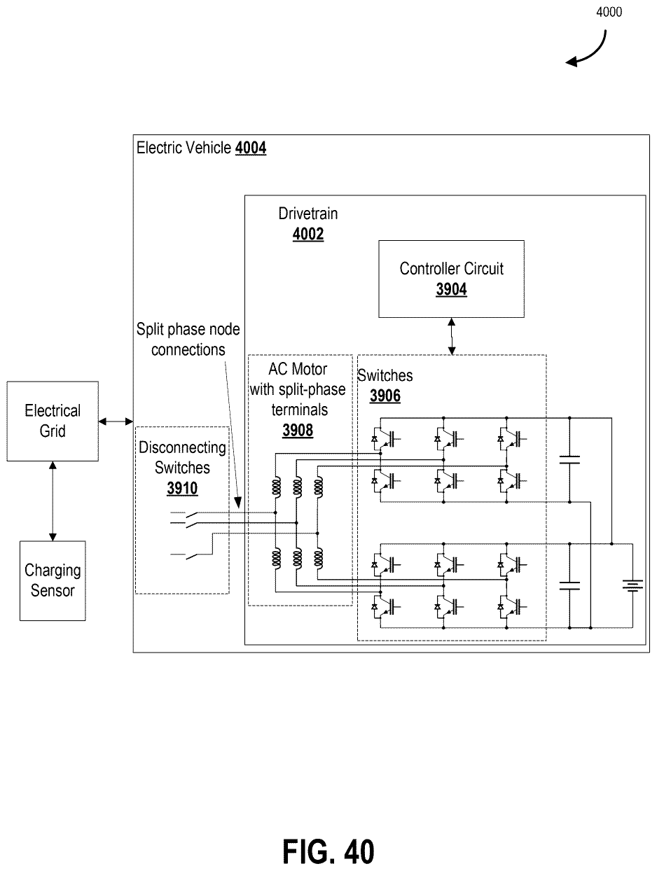

FIG. 40 is an example vehicle with an improved drivetrain, according to some embodiments. The vehicle is not limited to cars, but can include various types of electrical devices having an AC motor, such as cars, ships, planes, drones, etc. In other embodiments, even non-vehicle devices having AC motors are contemplated.

In the block diagram 4000, an electric vehicle 4004 is shown having drivetrain 4002 that has the components 3904, 3906, 3908, and 3910. The proposed embodiments can include any or all of these, or also the control software and/or embedded firmware for controlling switches in accordance to various embodiments above. For example, the software or firmware can include code or hardware circuits for controlling switch operation, such as logic gate control, and when executed by a processor, cause switch operation to occur in accordance with sequences described herein to perform methods for charging as described herein. The software or firmware can be affixed in the form of an article of manufacture, such as a non-transitory computer or machine readable medium storing instruction sets thereon.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

### Appendix: Single-Input αβ Decomposition

An oscillator system is described in prior approaches that, given an input sinusoidal quantity, e.g. a grid voltage, produces, in steady-state, the equivalent phasor representation of the input. The system has two state variables. The first, x₁, is in phase with, i.e. parallel to, the input, whereas the second, x₂, is 90° out of phase, i.e. perpendicular. The oscillator system, O(ωᵣ) can be described by the following two equations:

$$\frac{d}{dt} [ \begin{matrix}{x}_{1} \\ {x}_{2}\end{matrix} ] = [ \begin{matrix}- k & {ω}_{r} \\ - {ω}_{r} & 0\end{matrix} ] [ \begin{matrix}{x}_{1} \\ {x}_{2}\end{matrix} ] + [ \begin{matrix}k \\ 0\end{matrix} ] u ( t )$$

$$\vec{y} = [ \begin{matrix}1 & - j\end{matrix} ] [ \begin{matrix}{x}_{1} \\ {x}_{2}\end{matrix} ] ,$$

where ωᵣ is the resonant angular frequency for which the system is tuned.

The above equations allow one to practically compute the phasor representation of any sinusoidal signal. Moreover, the system attenuates all frequencies other than the resonant one. The parameter k defines a trade-off between how fast the system converges to the output phasor and how much attenuation is imposed onto non-resonant frequencies. The higher the value of k, the faster the system converges, but less attenuation is achieved.

### Appendix: Implementation of Proposed Modulation

The implementation of the modulator introduced in some embodiments herein can be achieved by the following sequence of steps:
1) Determine the sector i in which the reference voltage,

$${v}_{α , ch}^{*} + {jv}_{β , ch}^{*} lies .$$

2) Use the switching states sequence:

$$18 \to ( 2 i ) \% 12 \to ( 2 i + 3 ) \% 12 \to 19 \to ( 2 i + 1 ) \% 12 \to ( 2 i + 2 ) \% 12 \to 18 ,$$

where (x) % 12 denotes the reminder of the division of x by 12.
3) Determine the reference voltage rotated to its equivalent voltage in sector so,

$$[ \begin{matrix}{v}_{α , s 0} \\ {v}_{β , s 0}\end{matrix} ] = \text{?} \begin{matrix}\frac{1}{2} & - \frac{\sqrt{3}}{2} \\ \frac{\sqrt{3}}{2} & \frac{1}{2}\end{matrix} \text{?} [ \begin{matrix}{v}_{α , ch}^{*} \\ {v}_{β , ch}^{*}\end{matrix} ]$$

$$\text{?} \text{indicates text missing or illegible when filed}$$

4) Determine the active dwell times, based on

$$[ \begin{matrix}{t}_{( 2 i ) \% 12} \\ {t}_{( 2 i + 2 ) \% 12}\end{matrix} ] = [ \begin{matrix}{t}_{( 2 i + 1 ) \% 12} \\ {t}_{( 2 i + 3 ) \% 12}\end{matrix} ] = {\frac{\sqrt{3}}{2 {V}_{dc} {f}_{sw}} [ \begin{matrix}0 & \frac{\sqrt{3}}{2} \\ - 1 & - \frac{1}{2}\end{matrix} ]}^{- 1} [ \begin{matrix}{v}_{α , s 0}^{*} \\ {v}_{β , s 0}^{*}\end{matrix} ]$$

5) Determine the zero-vector dwell times, based on

$${t}_{18} = {t}_{19} = \frac{1}{2 {f}_{sw}} - ( {t}_{( 2 i ) \% 12} + {t}_{( 2 i + 2 ) \% 12} )$$

### Appendix—Single Phase Switching States

During single-phase operation, given the two connection points into the grid, only two degrees of freedom of the voltage are simultaneously fully defined and relevant.

These voltages the differential-mode voltage applied to the grid and the common-mode voltage applied to the grid.

Expressly, assuming that the grid interfaces with phases “a” and “b” of the inverter, the common-mode voltage applied by the charger onto the grid is:

$${v}_{cm , 1 ϕ} = \frac{{V}_{dc}}{4} ( {g}_{a , t} + {g}_{a , b} + {g}_{b , t} + {g}_{b , b} ) - \frac{{V}_{dc}}{2} ,$$

whereas the differential-mode voltage applied by the charger onto the grid is computed by:

$${v}_{dm , 1 ϕ} = \frac{{V}_{dc}}{4} ( {g}_{a , t} + {g}_{a , b} - {g}_{b , t} - {g}_{b , b} ) .$$

The following table outlines both the common-mode and the differential-mode voltage applied to the grid generated by the available switching states. As it was done in the three-phase case, for brevity, only the switching states that yield zero-common mode voltage, and therefore can be operated without causing nuisance tripping, are listed.

TABLE V
Voltages Applied to the Grid by Available Switching States

| State # | g_{a,t} | g_{b,t} | g_{a,b} | g_{b,t} | V_{cm,1φ} | V_{dm,1φ} |
|---|---|---|---|---|---|---|
| 0 | 0 | 0 | 1 | 1 | 0 | 0 |
| 1 | 0 | 1 | 0 | 1 | 0 | −V_{dc} |
| 2 | 0 | 1 | 1 | 0 | 0 | 0 |
| 3 | 1 | 0 | 0 | 1 | 0 | 0 |
| 4 | 1 | 0 | 1 | 0 | 0 | 0 |
| 5 | 1 | 1 | 0 | 0 | 0 | V_{dc} |

1. An electrical device system capable of charging an energy storage device of an electric vehicle, comprising:
a plurality of switches, each one connecting a terminal of the energy storage device to a respective terminal of an alternating-current (AC) motor, wherein the AC motor comprises at least six terminals connected to some of the plurality of switches and three split-phase nodes; and
a control circuit configured to control each of the plurality of switches for connecting the energy storage device to a respective terminal of the AC motor.

2. The system of claim 1, wherein during charging operation, at least two of the three split-phase nodes of the AC motor are connected to an electrical network.

3. The system of claim 2, wherein the control circuit, upon detecting that the electrical vehicle is connected to the electrical network during a charging operation, is configured to reduce a common-mode current flowing to the electricity network to prevent ground fault protection tripping.

4. The system of claim 2, wherein the control circuit is configured to reduce or eliminate torque production by controlling some of the plurality of switches connected to the terminals of the AC motor, and wherein terminals of the AC motor that are not directly connected to the switched node of the inverter half-bridges are connected to the electrical network.

5. (canceled)

6. The system of claim 1, wherein the control circuit is configured to apply zero average zero-sequence voltage to the motor stators throughout a switching period.

7. The system of claim 1, wherein, during single-phase charging operation, the control circuit is configured to reduce a second-harmonic-power-ripple flowing into and out of the energy storage device.

8. The system of claim 1, wherein the electrical device comprises a dual inverter architecture, and wherein the AC motor comprises a split-phase open winding machine driven by the dual inverter architecture.

9. (canceled)

10. The system of claim 1, further comprising a controller selection logic circuit configured to activate the control circuit upon detecting that the electrical vehicle is connected to an electricity network for charging the energy storage device.

11. The system of claim 1, further comprising:
an auxiliary capacitor or inductor connected to the plurality of switches for attenuating a second harmonic power ripple flowing to the energy storage device; an active phase decoupling (APD) control circuit configured to deliver an appropriate current rₐᵤₓ to the auxillary capacitor or inductor to ensure a current delivered to the energy storage device is minimized.

12. (canceled)

13. The system of claim 11, wherein rₐᵤₓ is delivered based on a voltage vₐᵤₓ, an auxiliary capacitor or inductor voltage for the auxiliary capacitor or inductor.

14. The system of claim 11, further comprising a controller selection logic circuit configured to activate the APD control circuit upon detecting that the electrical vehicle is connected to an electricity network for charging the energy storage device.

15. The system of claim 11, further comprising a controller selection logic circuit configured connect the auxiliary capacitor or inductor and the plurality of switches upon detecting that the electrical vehicle is connected to an electricity network for charging the energy storage device.

16. (canceled)

17. (canceled)

18. (canceled)

19. (canceled)

20. The system of claim 1, wherein the drivetrain of the electric vehicle is configured for switching between different single phase and three phase operation modes depending on a charge level of the energy storage device.

21. The system of claim 1, wherein the control circuit is configured to control the plurality of switches based upon at least upon a time-varying phasor determined using an oscillator coupled to an electrical grid input; and wherein the control circuit is configured to control an average power transfer between the electrical grid input and the energy storage device such that a grid current follows a grid current reference.

22. (canceled)

23. The system of claim 21, wherein the control circuit further includes a supervisory control feedback mechanism that is configured to set the grid current reference based on active and reactive power objectives.

24. The system of claim 21, wherein:
a grid voltage phasor is determined based at least upon extracted components of the time-varying phasor, including at least an angle ωt, and the grid voltage phasor is converted into a rotating reference frame (RRF), using the ωt as a reference;
a grid current phasor is rotated using a Park transformation with reference equal to the angle ωt, generating a RRF dg representation of the grid current;
the control circuit includes a control loop, and a current tracker error is provided into the control loop in each axis;
an output of the control loop signifies a voltage in RRF to be applied to an interfacing inductor, feeding forward a grid voltage to determine a voltage in dg frame of which the control circuit synthesizes to oppose the grid voltage;
the synthesized voltage in dg frame is rotated back into a stationary reference frame (SRF) using the angle ωt, and a real part is sent to a PWM modulator;
the PWM modulator controls the switches such that a second harmonic power ripple is attenuated; and
the energy storage device includes two batteries, and the second harmonic power ripple being attenuated flows to the two batteries.

25. (canceled)

26. (canceled)

27. (canceled)

28. (canceled)

29. (canceled)

30. (canceled)

31. The system of claim 1, wherein the control of each of the plurality of switches includes applying, during charging operation of the electric vehicle, a charging voltage \vec{v}_{ch} that is controlled to both avoid torque production and eliminate common mode voltage generated by the system, the charging voltage \vec{v}_{ch}; wherein a set of available switching states are defined where an instantaneous voltage, v_{0,ch} is controlled to be 0 at all times, to mitigate common mode current production, the set of variable switching states representing a set of available charging voltage space-vectors; and wherein operation of the electric vehicle is constrained to the set of available switching states where the instantaneous voltage, v_{0,ch} is controlled to be 0.

32. (canceled)

33. (canceled)

34. The system of claim 31, wherein the constraining of the operation of the electric vehicle is conducted through operation of a coupled modulator controlling operation of the plurality of switches.

35. The system of claim 31, wherein constraining the operation of the electric vehicle to the set of available switching states includes setting a sequence of switching states used by the system over a switching period.

36. The system of claim 35, wherein the sequence of switching states includes pairs of switching states where contribution towards an instantaneous driving voltage [symbol] v_{0,dr} [symbol] , are cancelled out.

37. The system of claim 35, wherein the sequence of switching states used by the system over a switching period includes controlling a duration of time spent at each switching state; and wherein the controlling of the duration of time spent at each switching state is utilized to cancel out a zero-sequence voltage.

38. (canceled)

39. The system of claim 31, wherein there are 64 states of operation and wherein the set of available switching states includes 20 available states.

40. (canceled)

41. A method for charging an energy storage device of an electric vehicle using a system having a plurality of switches, each one connecting a terminal of the energy storage device to a respective terminal of an alternating-current (AC) motor, wherein the AC motor comprises at least six terminals connected to some of the plurality of switches and three split-phase nodes, the method comprising:
controlling, using a control circuit, each of the plurality of switches for connecting the energy storage device to a respective terminal of the AC motor.

42. The method of claim 41, wherein during charging operation, at least two of the three split-phase nodes of the AC motor are connected to an electrical network.

43. The method of claim 42, wherein the method comprises, upon detecting that the electrical vehicle is connected to the electrical network during a charging operation, reducing a common-mode current flowing to the electricity network to prevent ground fault protection tripping.

44. The method of claim 42, wherein the control circuit is configured to reduce or eliminate torque production by controlling some of the plurality of switches connected to the terminals of the AC motor; and wherein terminals of the AC motor that are not directly connected to the switched node of the inverter half-bridges are connected to the electrical network.

45. (canceled)

46. The method of claim 41, wherein the control circuit is configured to apply zero average zero-sequence voltage to the motor stators throughout a switching period.

47. The method of claim 41, wherein, during single-phase charging operation, the control circuit is configured to reduce a second-harmonic-power-ripple flowing into and out of the energy storage device.

48. The method of claim 41, wherein the electrical device comprises a dual inverter architecture; and wherein the AC motor comprises a split-phase open winding machine driven by the dual inverter architecture.

49. (canceled)

50. The method of claim 41, further comprising a controller selection logic circuit configured to activate the control circuit upon detecting that the electrical vehicle is connected to an electricity network for charging the energy storage device.

51. The method of claim 41, further comprising:
connecting an auxiliary capacitor or inductor to the plurality of switches for attenuating a second harmonic power ripple flowing to the energy storage device;
delivering, by an active phase decoupling (APD) control circuit, an appropriate current rₐᵤₓ to the auxiliary capacitor or inductor to ensure a current delivered to the energy storage device is minimized.

52. (canceled)

53. The method of claim 51, wherein rₐᵤₓ is delivered based on a voltage vₐᵤₓ, an auxiliary capacitor or inductor voltage for the auxiliary capacitor or inductor.

54. The method of claim 51, further comprising activating the APD control circuit upon detecting that the electrical vehicle is connected to an electricity network for charging the energy storage device.

55. The method of claim 51, further comprising connecting the auxiliary capacitor or inductor and the plurality of switches upon detecting that the electrical vehicle is connected to an electricity network for charging the energy storage device.

56. (canceled)

57. (canceled)

58. (canceled)

59. (canceled)

60. The method of claim 41, wherein the drivetrain of the electric vehicle is configured for switching between different single phase and three phase operation modes depending on a charge level of the energy storage device.

61. The method of claim 41, wherein the control circuit is configured to control the plurality of switches based upon at least upon a time-varying phasor determined using an oscillator coupled to an electrical grid input; and wherein the control circuit is configured to control an average power transfer between the electrical grid input and the energy storage device such that a grid current follows a grid current reference.

62. (canceled)

63. The method of claim 61, wherein the control circuit further includes a supervisory control feedback mechanism that is configured to set the grid current reference based on active and reactive power objectives.

64. The method of claim 61, wherein:
a grid voltage phasor is determined based at least upon extracted components of the time-varying phasor, including at least an angle ωt, and the grid voltage phasor is converted into a rotating reference frame (RRF), using the ωt as a reference;
a grid current phasor is rotated using a Park transformation with reference equal to the angle ωt generating a RRF dg representation of the grid current;
the control circuit includes a control loop, and a current tracker error is provided into the control loop in each axis;
an output of the control loop signifies a voltage in RRF to be applied to an interfacing inductor, feeding forward a grid voltage to determine a voltage in dg frame of which the control circuit synthesizes to oppose the grid voltage;
the synthesized voltage in dg frame is rotated back into a stationary reference frame (SRF) using the angle ωt, and a real part is sent to a PWM modulator;
wherein the PWM modulator controls the switches such that a second harmonic power ripple is attenuated; and
the energy storage device includes two batteries, and the second harmonic power ripple being attenuated flows to the two batteries.

65. (canceled)

66. (canceled)

67. (canceled)

68. (canceled)

69. (canceled)

70. (canceled)

71. The method of claim 41, wherein the control of each of the plurality of switches includes applying, during charging operation of the electric vehicle, a charging voltage \vec{v}_{ch} that is controlled to both avoid torque production and eliminate common mode voltage generated by the system, the charging voltage \vec{v}_{0,ch}; wherein a set of available switching states are defined where an instantaneous voltage, v_{0,ch} is controlled to be 0 at all times to mitigate common mode current production, the set of available switching states representing a set of available charging voltage space-vectors; and wherein operation of the electric vehicle is constrained to the set of available switching states where the instantaneous voltage, v_{0,ch} is controlled to be 0.

72. (canceled)

73. (canceled)

74. The method of claim 71, wherein the constraining of the operation of the electric vehicle is conducted through operation of a coupled modulator controlling operation of the plurality of switches.

75. The method of claim 71, wherein constraining the operation of the electric vehicle to the set of available switching states includes setting a sequence of switching states used by the method over a switching period.

76. The method of claim 75, wherein the sequence of switching states includes pairs of switching states where contribution towards an instantaneous driving voltage [symbol] v_{0,dr} [symbol] , are cancelled out.

77. The method of claim 75, wherein the sequence of switching states used by the system over a switching period includes controlling a duration of time spent at each switching state; and wherein the controlling of the duration of time spent at each switching state is utilized to cancel out a zero-sequence voltage.

78. (canceled)

79. The method of claim 71, wherein there are 64 states of operation; and wherein the set of available switching states includes 20 available states.

80. (canceled)

81. A non-transitory machine readable medium, storing machine interpretable instruction sets, which when executed by a processor, cause the processor to perform a method for charging an energy storage device of an electric vehicle using a system having a plurality of switches, each one connecting a terminal of the energy storage device to a respective terminal of an alternating-current (AC) motor, wherein the AC motor comprises at least six terminals connected to some of the plurality of switches and three split-phase nodes, the method comprising: controlling, using a control circuit, each of the plurality of switches for connecting the energy storage device to a respective terminal of the AC motor.
